(19) United States
(12) Patent Application Publication
(10) Pub. No.: US 2013/0205014 A1
(43) Pub. Date: Aug. 8, 2013

(54) COMPUTER SYSTEM AND RULE GENERATION METHOD

(71) Applicants: Keiro Muro, Koganei (JP); Sadaki Nakano, Kokubunji (JP)

(72) Inventors: Keiro Muro, Koganei (JP); Sadaki Nakano, Kokubunji (JP)

(73) Assignee: Hitachi, Ltd.

(21) Appl. No.: 13/698,163

(22) PCT Filed: Feb. 21, 2011
(86) PCT No.: PCT/JP2011/053688

§ 371 Date: Jan. 25, 2013

(30) Foreign Application Priority Data
May 17, 2010 (JP) 2010-113175

(51) Int. Cl. H04L 29/06

(52) U.S. Cl. CPC H04L 29/06891
USPC 709/224

(57) ABSTRACT

Disclosed is a computer system provided with a plurality of sensors provided in a plurality of devices to observe a predetermined amount, and a server for examining the physical amount transmitted from the sensors, wherein the plurality of devices are classified into a first device group and a plurality of second device groups, a plurality of second examination rules indicating the examination methods of the physical amount are set in the plurality of second device groups, the server calculates the similarity between the first device group and each of the second device groups, and, on the basis of the calculated similarity, a first examination rule to be set in the first device group is extracted from the plurality of second examination rules set in the plurality of second device groups.

### CROSS-REFERENCE TO RELATED APPLICATIONS

The present application claims priority from Japanese patent application JP 2010-113175 filed on May 17, 2010, the content of which is hereby incorporated by reference into this application.

### TECHNICAL FIELD

The present invention relates to a computer system, and relates in particular to a computer system for examining a physical amount measured in a device, etc.

### BACKGROUND ART

Plants such as thermal power plants and nuclear power plants utilize systems for swiftly detecting device abnormalities and maintaining device to ensure the safe operation of device within the plant. In these types of systems, sensors are installed in each device in order to detect indications of abnormal device or indications that might lead to abnormal device, and the systems collect physical amounts (hereafter, “quantities”) measured by the sensors and by diagnose these accumulated physical quantities to diagnose abnormalities in each piece of device.

These device abnormalities can be diagnosed by establishing rules in advance that show what calculation formula to utilize for the measured physical quantity. The rules established for this type of diagnosis are sometimes generated by applying calculation formulas utilized in similar device structures in similar systems.

Japanese Unexamined Patent Application Publication No. 2007-094538 discloses for instance, an airport light maintenance system that extracts failure histories containing similar peripheral information when a failure has for example been found in the lights within an airport facility; and estimates the cause of the failure by comparing past failure histories with peripheral information on the environment (temperature, rainfall amount) where the failure occurred, the number of replacements of failed lights, the number of sub-stations, power cable total extension lengths between main station and sub-stations, and identical airports and identical type circuits.

The International Patent Publication No. WO03/055145 pamphlet discloses technology for estimating the cause of failure when a failure has been found in a communication path where a plurality of relay devices are coupled in numerous stages, by searching the failure histories of communication paths having a connecting structure similar to that (problem) communication path.

### SUMMARY OF INVENTION

### Technical Problems

Abnormality indicator diagnostic services for diagnosing a device abnormality or an indication leading to a device abnormality require that new rules be written for diagnosing abnormalities when providing diagnostic services to new customers or when the customer's device has been modified or additions to the device have been made.

Abnormality indicator diagnosis of the related art utilizing vector quantize clustering is capable of making a diagnosis by using statistical techniques to analyze plural measured physical quantities, in other words, observation values, and so can diagnose an abnormality without analyzing the cause of the failure as performed in the previously described technology of the related art.

However, when making an abnormality indicator diagnosis using VQC to diagnose a large number of unrelated observation values, the problem of so-called, “curse of dimensionality” occurs and the abnormality detection accuracy worsens. In other words, increasing the observation values increases the number of quantitative parameters for indicating the abnormal phenomenon. Increasing the number of parameters serves to exponentially increase the number of abnormal phenomenon patterns so that pinpointing the abnormality becomes impossible.

Abnormality indicator diagnosis using VQC therefore required selecting the observation values needed in the diagnosis, but in the related art the administrator or person in charge selected these observation values through trial-and-error or through past experience. Selection of these observation values also requires many man-hours. Rules must be drawn up for example for 20,000 sensors at a thermal power plant and a large number of man-hours are required for setting which observation values to measure.

The VQC moreover requires learning data (codebook) for making the diagnosis. In the related art however, the codebook must be newly made for relearning when the device structure is different, causing the problem that utilization is impossible until all the abnormal phenomenon have been accumulated as information.

The present invention has the object of providing rules for making a diagnosis in the maintenance system by way of VQC.

### Solution to Problem

A typical aspect of the present invention disclosed in the present application is given as follows. Namely, a computer system including a plurality of sensors installed in plural devices to measure specified physical quantities and a server to diagnose the physical quantities sent from the sensor; and in which, the plural devices are classified into a first device groups and a plurality of second device groups; and the plural second device groups contain a plurality of second examination rules showing diagnosis methods for the physical quantities; and the server calculates the similarity between the first device group and each of the second device groups; and extracts a first examination rule set in the first device group from the plural second examination rules set in the plural second device groups based on the calculated similarity.

### Advantageous Effects of Invention

The typical embodiment of the present invention renders the effect of reducing the man-hours for setting the examination rules in a new device.

### BRIEF DESCRIPTION OF DRAWINGS

FIG. 1 is a block diagram showing the system of the first embodiment of the present invention;

FIG. 2 is a block diagram showing the hardware structure of the examination server of the first embodiment of the present invention;

FIG. 3 is a block diagram showing the examination server function in the first embodiment of the present invention;

FIG. 4 is a block diagram showing the processing by the examination server in the first embodiment of the present invention;

FIG. 5 is a flow chart showing the diagnostic processing by the examination executer unit of the first embodiment of the present invention;

FIG. 6 is a descriptive drawing showing an example applying a device cluster to new devices in the first embodiment of the present invention;

FIG. 7 is a descriptive drawing showing the structure of the device graph in the first embodiment of the present invention;

FIG. 8 is a descriptive drawing showing the data structure of device information and sensor information in the first embodiment of the present invention;

FIG. 9 is a descriptive drawing showing a specific example of the device information and sensor information of the first embodiment of the present invention;

FIG. 10 is a descriptive drawing showing the structure of the sensor selector unit and sensor selection rule in the first embodiment of the present invention;

FIG. 11A is a descriptive drawing showing an observation value processing rule of the first embodiment of the present invention;

FIG. 11B is a descriptive drawing showing an example of processing by the observation value processor unit in the first embodiment of the present invention;

FIG. 12 is a flow chart showing frequency analysis by the observation value processor unit in the first embodiment of the present invention;

FIG. 13A is a descriptive drawing showing an example of the event distribution in the first embodiment of the present invention;

FIG. 13B is a descriptive drawing showing the relation between the event cluster and the feature vector in the first embodiment of the present invention;

FIG. 13C is a descriptive drawing showing the (math) function for calculating the reliability in the first embodiment of the present invention;

FIG. 14 is descriptive drawing showing the input/output data for VQC by the examination unit of the first embodiment of the present invention;

FIG. 15 is a flowchart showing the VQC by the examination unit of the first embodiment of the present invention;

FIG. 16 is a flow chart showing an overview of the processing for generating a device cluster in the first embodiment of the present invention;

FIG. 17 is a flow chart showing in detail the processing for generating a device cluster in the first embodiment of the present invention;

FIG. 18A is a descriptive drawing showing a specific example for acquiring similar device graphs in the first embodiment of the present invention;

FIG. 18B is a descriptive drawing showing the generation of a sensor selection rule in the first embodiment of the present invention;

FIG. 19 is a flow chart showing the procedure for acquiring similar device graphs in the first embodiment of the present invention;

FIG. 20 is a flow chart showing the method for calculating the similarity of the device graphs in the first embodiment of the present invention;

FIG. 21 is a flow chart showing the procedure for calculating the similarity of the nodes in the first embodiment of the present invention;

FIG. 22 is a descriptive drawing showing a specific example of calculating the attribute distance in the first embodiment of the present invention;

FIG. 23 is a flow chart showing the procedure for calculating the similarity coefficient in the first embodiment of the present invention;

FIG. 24A is a descriptive drawing showing an example of the device cluster distance in the first embodiment of the present invention;

FIG. 24B is a descriptive drawing showing an example of the event cluster distance in the first embodiment of the present invention;

FIG. 25 is a descriptive drawing showing an example of applying a device cluster to a new plant in the second embodiment of the present invention.

### DESCRIPTION OF EMBODIMENTS

### First Embodiment

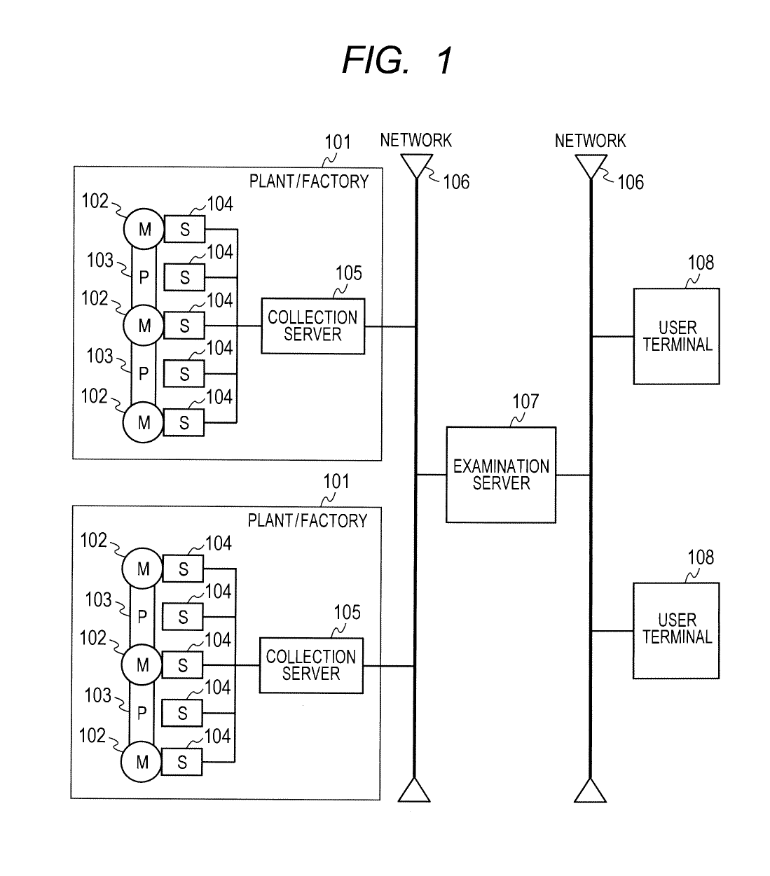

FIG. 1 is a block diagram showing the system of the first embodiment of the present invention.

The system of the embodiment of the present invention includes the sensors 104, a collection server 105, a network 106, and an examination server 107.

The sensors 104 are respectively mounted in the devices 102 and pipes 103 installed within the plant 101 and measure the observation values such as vibration, heat, or rotation speed generated in the devices 102 and pipes 103. A plant 101 is an electrical generating plant or factory, etc. The plant 101 contains the devices 102 and the pipes 103. The devices 102 are a motor or a pump, etc., and the pipes 103 are pipes or cables that connect the devices 102 to each other. The collection server 105 collects observation values measured by the sensors. The collection server 105 sends the measured observation values to the examination server 107 byway of the network 106.

In the present embodiment the plant 101 is an electrical power plant and so on but if a system for measuring the observation values by way of the sensor 104, and collecting measured observation values, then the system can apply to any plant.

The network 106 is a LAN (Local Area Network), WAN (Wide Area Network) or may be any network of the Internet. The examination server 107 analyzes the observation values sent from the collection server 105 and judges whether or not a phenomenon indicating an abnormality has occurred. The examination server 107 sends the examination results to the user terminal 108 by way of the network 106. The user terminal 108 displays the examination results so that the user can view the examination results.

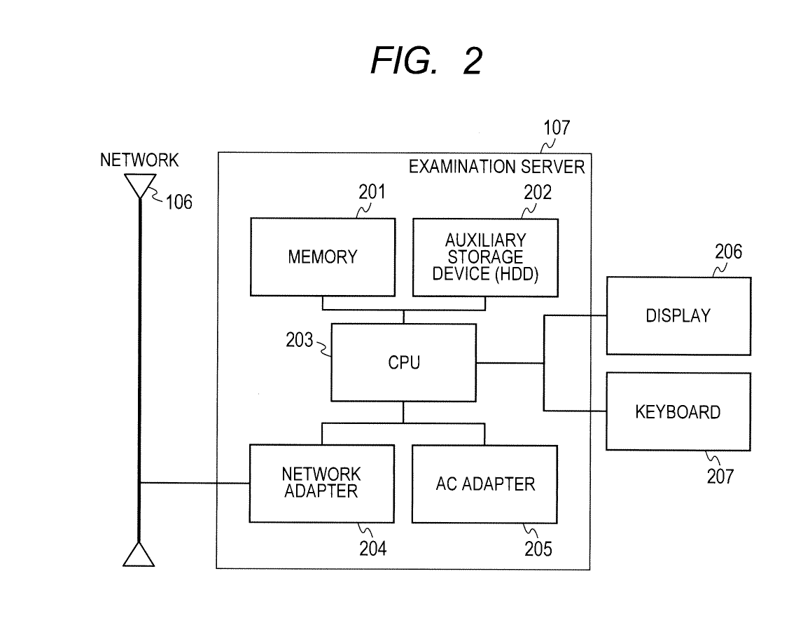

FIG. 2 is a block diagram showing the hardware structure of the examination server 107 of the first embodiment of the present invention.

The examination server 107 includes an auxiliary storage device 202, a CPU203, a network adapter 204, an AC adapter 205, a display 206, and a keyboard 207. When executing the program, the CPU203 runs the program in a memory 201, and utilizes the memory 201 as a temporary storage (buffer) area. The auxiliary storage device 202 is a non-volatile storage device (for example a magnetic disk drive) where a program executed by the CPU203 and data, etc. are stored. The CPU203 executes the program in order to analyze the observation values measured by the sensors 104 and judges whether or not a phenomenon indicating an abnormality has occurred.

The network adapter 204 receives the observation value sent from the collection server 105 byway of the network 106, and is also a network interface for sending results diagnosed in the CPU203 to the user terminal 108 by way of the network 106. The AC adapter 205 is a power supply device for supplying electrical power to the examination server 107.

The display 206 is an output device for displaying the examination results from the examination server 107 to allow viewing by the administrator. The keyboard 207 is an input device for allowing the administrator to input parameters for making a diagnosis.

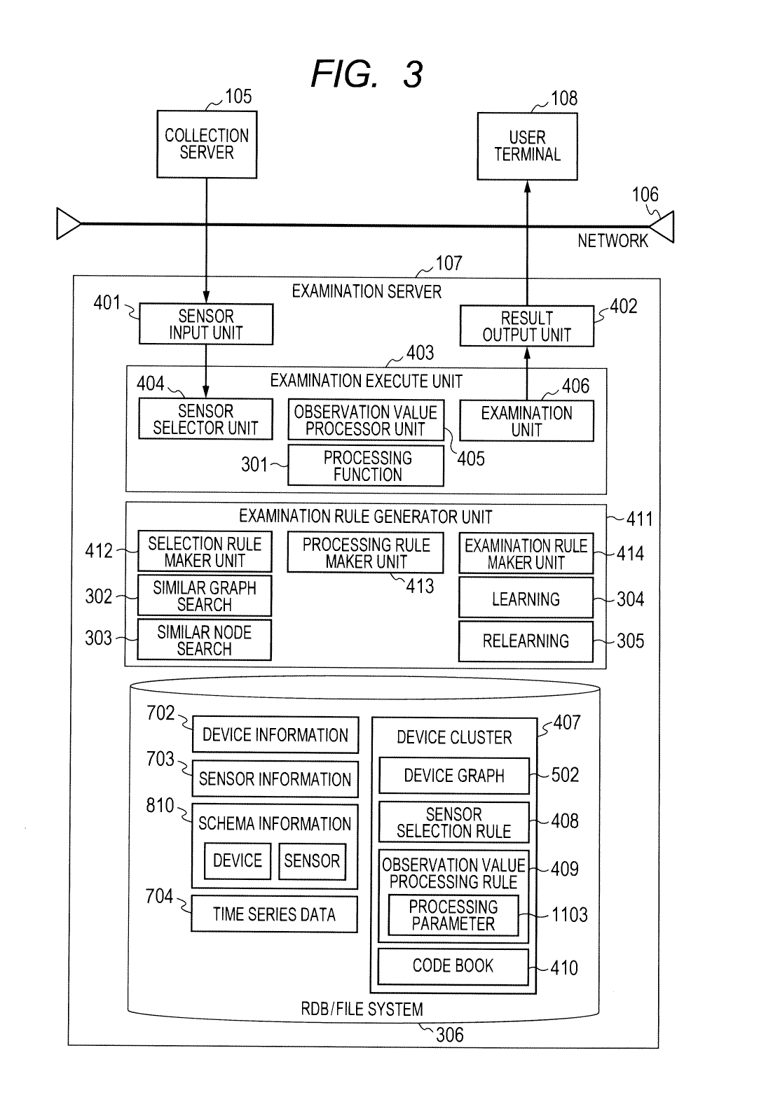

FIG. 3 is a block diagram showing the function of the examination server 107 in the first embodiment of the present invention.

The examination server 107 includes a sensor input unit 401, a result output unit 402, an examination rule generator unit 411, and an RDB306.

The sensor input unit 401 receives the observation values sent from the collection server 105, and send the received observation values to the examination executer unit 403. The result output unit 402 sends the results diagnosed (examined) by the examination executer unit 403 to the user terminal 108.

The examination executer unit 403 includes a sensor selector unit 404, an observation value processor unit 405, an examination unit 406, and a processor function 301. The examination executer unit 403 judges whether or not a phenomenon indicating an abnormality has occurred based on the observation values that were sent.

The sensor selector unit 404 is a program for analyzing the observation values that were sent, and selecting which sensor observation values to utilize for the diagnosis. The observation value processor unit 405 is a program for processing the observation value utilized in functions such as Fourier transforms, and selecting which observation values among the processed observation values to utilize for the diagnosis. The examination unit 406 is a program for diagnosing the observation values by methods such as VQC described later on. The processor function 301 is a function utilized in the observation value processor unit 405, and is a sub-routine of the observation value processor unit 405.

The examination rule generator unit 411 includes a selection rule maker unit 412, a processing rule maker unit 413, an examination rule maker unit 414, a similar graph search unit 302, a similar node search unit 303, a learning unit 304, and a relearning unit 305. Each program in the examination executer unit 403 diagnoses (or examines) the observation values by way of the rules made or rewritten by the examination rule generator unit 411.

The selection rule maker unit 412 is a program for making selection rules utilized in the sensor selector unit 404. The similar graph search unit 302 and the similar node search unit 303 are sub-routines of the selection rule maker unit 412. The processing rule maker unit 413 is a program for making rules for processing observation values utilized in the observation value processor unit 405. The examination rule maker unit 414 is a program for making examination rules utilized in the examination unit 406. The learning unit 304 and the relearning unit 305 are sub-routines of the examination rule maker unit 414.

The RDB306 stores the device information 702, the sensor information 703, the schema information 810, the time-series data 704, and the device cluster 407. The RDB306 can be a file system or a relational DB (Database) mounted in the memory 201.

The device information 704 is information showing what type of device 102 and pipe 103 are present within the system, and how the device 102 and pipe 103 are connected. The device information 702 is stored beforehand by the administrator and so on in the RDB306.

More specifically, the device information 702 contains an identifier showing the unique device 102 and pipe 103, names of the device 102 or pipe 103 (e.g. pump), and the type of operation of the device 102 or pipe 103 (e.g. rotation), the installation date of the device 102 or pipe 103, and an identifier showing the connected device 102 or pipe 103, etc. The device information 702 is shown by numbers or character strings.

The sensor information 703 is information showing what the specifications are for each sensor inside the system. The administrator or other party stored the sensor information 703 beforehand in the RDB306.

More specifically, the sensor information 703 stores attribute information showing the identifiers or names of the connected device 102 or pipe 103, the object for measurement (e.g. rotation speed, temperature, etc.) observation value units (e.g. rpm, ° C., and so on), and measurement period (e.g. minutes and so on). The sensor information 703 is shown by way of numbers or character strings.

The schema information 810 is information showing what type of information is stored in the device information 702 and the sensor information 703. More specifically, the schema information 810 showing the device information 702, includes an identifier showing the unique device 102 or pipe 103, a name of the device 102 or pipe 103, the type of operation of the device 102 or pipe 103, the installation date of the device 102 or pipe 103, and an identifier showing the connected device 102 or pipe 103.

The schema information 810 showing the sensor information 703 further contains, identifiers showing the sensor information 703, identifiers or names of the connected devices 102 or the pipes 103, object for measurement (e.g. rotation speed, temperature, etc.), observation value units (e.g. rpm, ° C., and so on) and measurement period (e.g. 5 minutes and so on).

The time-series data 704 stores the observation values measured by the sensor 104 in their time-series order. More specifically, the measurement time, identifier showing the sensor 104 that made the measurement, and the observation value are stored in the time-series data 704.

The device cluster 407 contains a device graph 502, a sensor selection rule 408, an observation value processing rule 409, a processing parameter 1103, and a code book 410. Among the devices 102 and pipes 103, the device cluster 407 is information on the device 102 and pipe 103 combinations that require diagnosis together. One device cluster may contain at least one device 102 or pipe 103.

The device graph 502 contains identifiers showing each unique device 102 or pipe 103, and information such as how the device 102 or pipe 103 is installed and at what distances. The device graph 502 for example contains information such as that a pump and pipe are connected, or information that a turbine and pipe are installed 30 centimeters apart.

Among the sensors 104 connected to the devices 102 or the pipe 103 shown in the device graph 502; the sensor selection rule 408 contains information showing what observation values are utilized by which sensor 104.

The observation value processing rule 409 contains information showing how to process observation values that were measured on the device 102 or the pipe 103 shown in the device graph 502. The processing parameter 1103 is a parameter utilized in functions in cases where the observation value processing rule 409 is the function.

The codebook 410 stores parameters for making a diagnosis. Namely, the codebook 410 stores examination rules for diagnosing, what type of observation value shows what type of event at what numerical value.

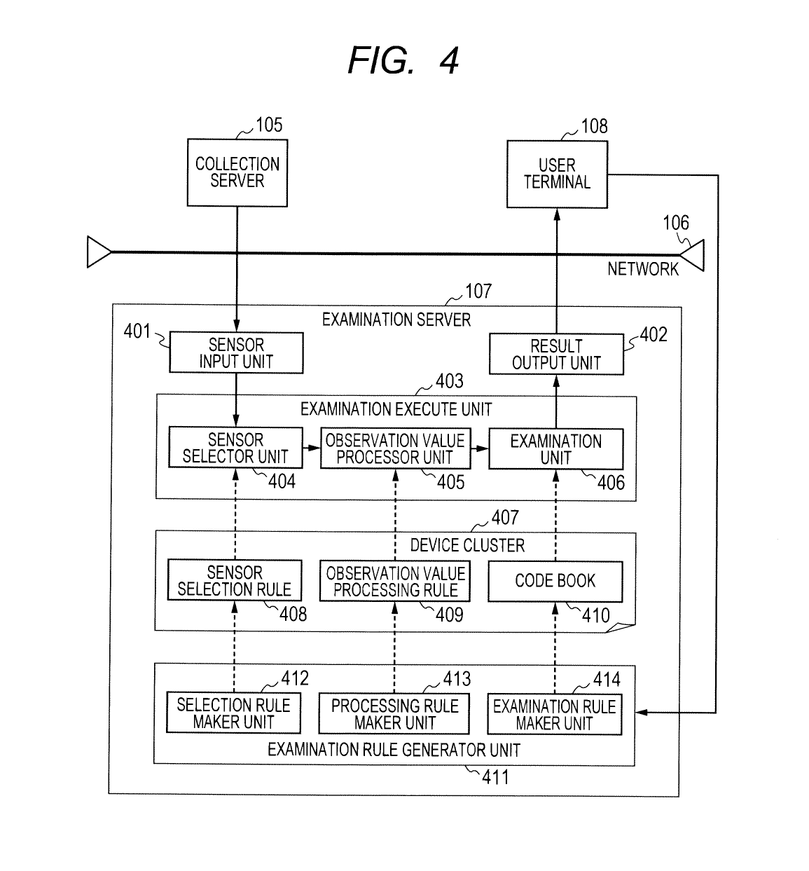

FIG. 4 is a block diagram showing the processing by the examination server 107 in the first embodiment of the present invention.

The sensor selector unit 404 selects which sensor observation value to utilize for the diagnosis when an observation value is received from the collection server 105 by way of the sensor input unit 401. Moreover in order to select the sensor, the sensor selector unit 404 refers to the sensor selection rule 408 made by the selection rule maker unit 412.

When an observation value for a sensor selected by the sensor selector unit 404 is received, the observation value processor unit 405 processes the observation value that was received, and selects which observation value to utilize for the diagnosis from among the processed observation values. In order to process the observation value, the observation value processor unit 405 also refers to the observation value processing rule 409 made by the processing rule maker unit 413.

When an observation value processed by the observation value processor unit 405 is received, the examination unit 406 proceeds to diagnose that received observation value. Moreover, in order to diagnose the observation value, the examination unit 406 searches the code book 410 made by the examination rule maker unit 414.

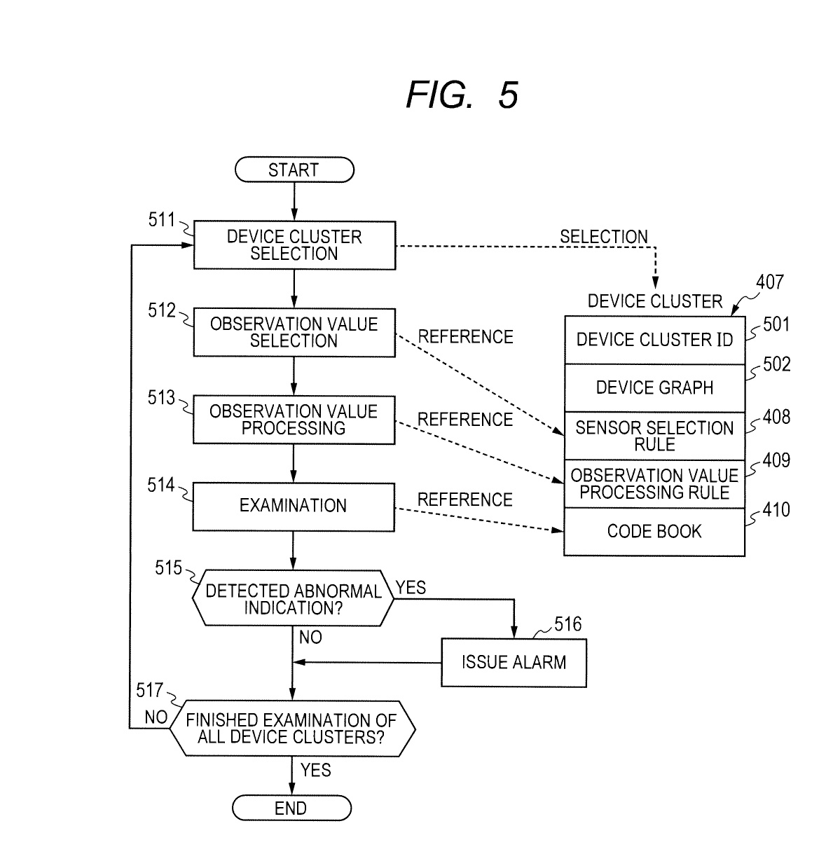

FIG. 5 is a flow chart showing the diagnostic processing by the examination executer unit 403 of the first embodiment of the present invention.

The device cluster 407 shown in FIG. 5 includes a device cluster ID501, a device graph 502, a sensor selection rule 408, an observation value processing rule 409, and a code book 410. The device cluster ID501 is an identifier showing a unique device cluster 407.

The examination executer unit 403 implements the flow chart (processing) shown in FIG. 5 when the observation value sent from the collection server 105 is a fixed cumulative quantity for each device cluster 407. In other words, when the observation value sent from the collection server 105 is a fixed cumulative quantity for each device cluster 407, the examination executer unit 403 selects the device cluster 407 where the observation value has been accumulated (Step 511). The examination executer unit 403 then sends the selected observation value for the device cluster 407 to the sensor selector unit 404.

The sensor selector unit 404 selects which sensor observation value to utilize by searching the sensor selection rule 408 contained in the device cluster 407 selected in step 511 (step 512). The sensor selector unit 404 then sends the selected sensor observation value to the observation value processor unit 405.

The observation value processor unit 405 processes (step 513) the observation value selected in step 512 by searching the observation value processing rule 409 contained in the device cluster 407 selected in step 511 (step 513). The observation value processor unit 405 then sends the processed observation value to the examination unit 406.

The examination unit 406 diagnoses the observation values processed in step 513 by searching the code book 410 contained in the device cluster 407 selected in step 511 (step 514). There are plural observation values processed by the observation value processor unit 405 and each show a different phenomenon. These plural observation values are therefore shown by a feature vector. The examination unit 406 converts the observation values shown by the feature vector into scalar values in this step 514.

The examination unit 406 compares the observation values converted into scalar values in step 514, with pre-established threshold values (step 515) and if those results are values showing the observation values are abnormal or namely if indications of an abnormality are detected, issues a warning (step 516). The examination unit 406 may issue a warning by displaying a warning on a display 206 or may issue a warning by sending a message signifying a warning to the user terminal 108. Information showing abnormality indications even other than a warning may be retained in the RDB306, etc.

In step 515, when there is no observation value indicating an abnormality in step 515, or after the warning was issued in step 516, the examination executer unit 403 decides whether or not the diagnosis for all device clusters 407 has ended or not by judging whether the observation values sent from the collection server 105 have accumulated to a specified quantity or not (step 517). If the diagnosis has not ended then the examination executer unit 403 returns to step 511. If the diagnosis has ended then the examination executer unit 403 terminates the processing and waits for observation values to accumulate.

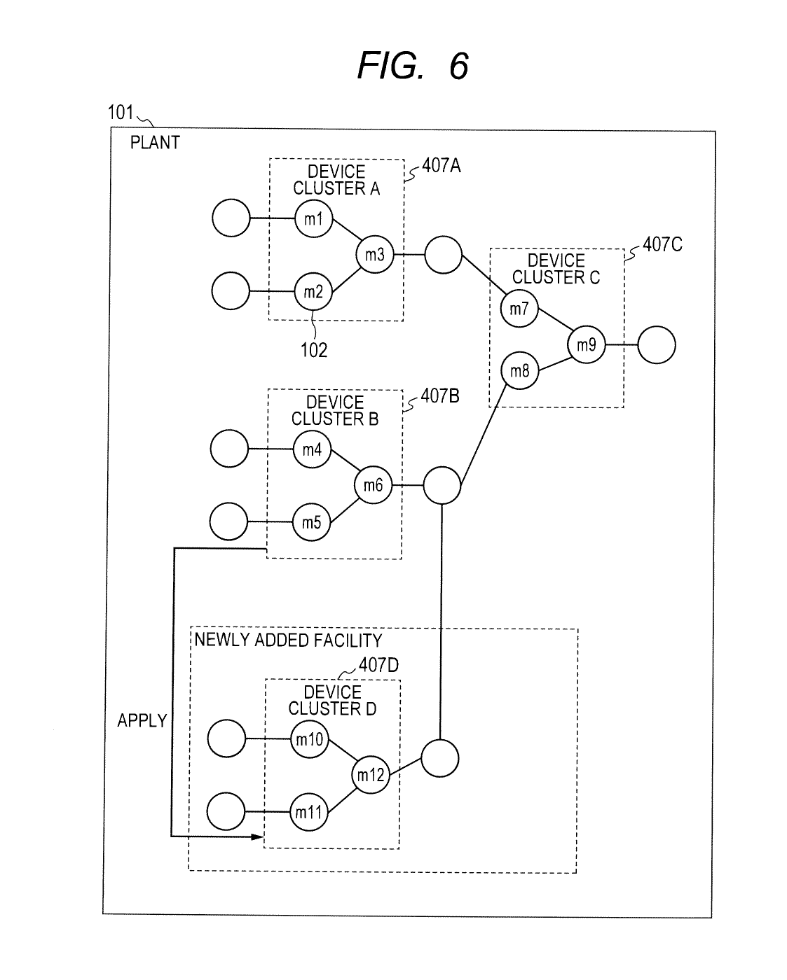

FIG. 6 is a descriptive drawing showing an example applying a device cluster 407 to a new device 102 in the first embodiment of the present invention.

FIG. 6 shows the connective relation of the device 102 or pipe 103 contained within the one plant 101.

The device 102 and the pipe 103 are shown (m1 through m12) in FIG. 6. Each of the devices 102 and pipes 103 are connected by way of a tree structure. The example shown in FIG. 6, describes only the device 102 but the connectional relation may also include the pipe 103. The connectional relation for the device 102 shown in FIG. 6 is a connectional relation for the device 102 contained the plant 101, however a connectional relation within a specified department within the plant 101 is also allowed.

As already described, the connectional relation of the devices 102 requiring collective diagnosis of the observed observation values is shown by the device graph 502, and the device clusters 407 are assigned to the device graph 502. The device cluster 407 shown in FIG. 6 includes a device cluster 407A assigned to the devices and pipes m1-m3, the device cluster 407B assigned to the devices and pipes m4-m6, and the device cluster 407C assigned to the devices and pipes m7-m9.

This drawing shows the case where a facility containing a new device 102 has been newly added to the plant 101. Among the newly added plural devices 102, the examination rule generator unit 411 of the present embodiment searches for device graphs 502 resembling the already existing device graph 502, and generates a device cluster 407 for the newly added facility by applying a new device 102 to the device cluster 407 stored in the device graph 502 that was searched.

In the example shown in FIG. 6, when the device graph 502 including the devices and pipes m4-m6, is similar to the device graph 502 including the devices and pipes m10-m12, the device cluster 407D is generated for devices and pipes m10-m12 by applying the device cluster 407B including the devices and pipes m4-m6 to the devices and pipes m10-m12.

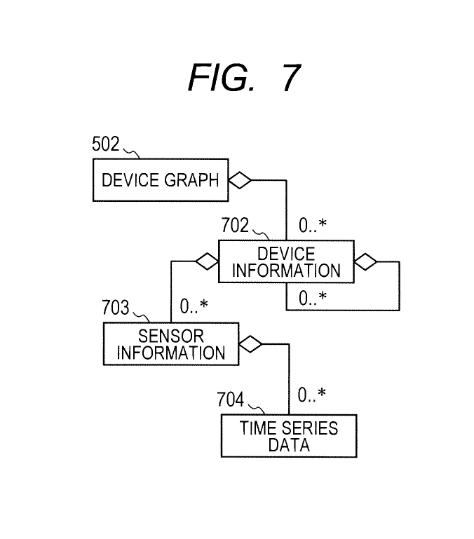

FIG. 7 is a descriptive drawing showing the structure of the device graph 502 in the first embodiment of the present invention.

The device graph 502 includes 0 or one or more device information 702, and these device information 702 are concentrated in the device graph 502. In some cases the device information 702, 0 or one or more device information 702 are contained in another device information 702. If a pipe (pipe 103) is for example connected to a pump (device 102), then the device information 702 for the pipe is contained in the device information 702 for the pump.

If the number of device information 702 is 0, then there are no devices 102 contained in the device graph 502 so there is also no device cluster 407.

The device information 702 includes one or more sensor information 703, and these sensor information 703 are concentrated in the device information 702. The sensor information 703 shows the sensor 104 connected to the device information 702. The sensor information 703 also includes 0 or one or more time-series data 704, and this time-series data 704 is concentrated in the sensor information 703. The time-series data 704 includes observation values that were measured by the sensor 104.

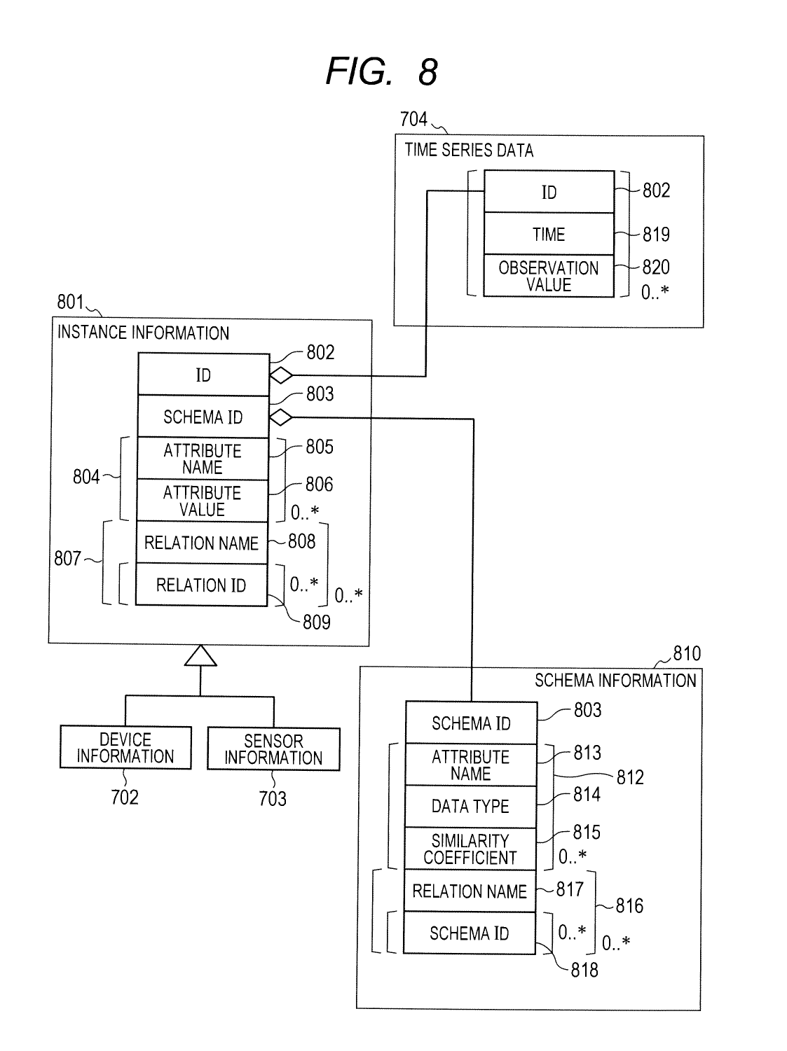

FIG. 8 is a descriptive drawing showing the data structure of the device information 702 and the sensor information 703 in the first embodiment of the present invention.

The device information 702 and the sensor information 703 both include data structures shown in the instance information 801. The instance information 801 contains an ID802, a schema ID803, an attribute 804, and a relation 807. The ID802 is an identifier showing a unique device 102 or the pipe 103, or the sensor 104. In the following description, the ID802 corresponding to the device 102 or pipe 103 is displayed as device ID802, the ID802 corresponding to the sensor 104 is displayed as the sensor ID802. The schema ID803 is an identifier showing the unique applicable schema information 810.

The attribute 804 includes the attribute name 805 and the attribute value 806. The attribute name 805 indicates the attribute of the device information 702 or the sensor information 703 and includes for example the name of the device 102 or the pipe 103, the type of operation, and the installation date, etc. The attribute value 806 shows the corresponding value for the attribute name 805, and includes for example, pump, rotation, Jan. 1, 2010, etc.

The relation 807 includes the relation name 808 and the relation ID809. The relation name 808 shows the relation between the device 102 or the pipe 103 or the sensor 104 indicated by the relation ID809 and the device 102 or the pipe 103 or the sensor 104 shown by the ID802; and for example indicates a “connection” or “inclusion” etc. The relation ID indicates an identifier for another related device 102 or pipe 103, or indicates an identifier for a connected sensor 104.

The instance information 801 contains 0 or one or more attributes 804. The instance information 801 also contains 0 or one or more relations 807. The relation 807 further contains 0 or one or more relations ID809.

The time-series data 704 includes the ID802, the time 819, and the observation value 820. There are 0 or one or more time-series data 704 present. The ID802 are concentrated in the ID802 included in the instance information 801. The time 819 shows the time that the observation value 820 was measured. The observation value 820 shows the observation value that was measured in the device 102 or the pipe 103. The time-series data 704 is related to the sensor information 703.

The schema information 810 includes a schema ID803, 0 or one or more attribute schema 812, and 0 or one or more relation schema 816. The schema ID803 is concentrated in the ID802 contained in the instance information 801.

The attribute schema 812 includes the attribute name 813, the data type 814, and the similarity coefficient 815. The attribute name 813 is the same as the attribute name 805, and includes the name of the device 102 or the pipe 103, the type of operation, and the installation date, etc. The data type 814 shows the data type of the attribute shown in the attribute name 813. If the attribute name 813 for example is a name of a device 102 or pipe 103, then the data type 814 shows a character string, and if the attribute name 813 is an installation date then the data type 814 shows a date type.

Beside the above described examples, the attribute name 813 may also include attributes such as the installation position, the production manufacturer's name, the average performance, the need (or not) for calibration (namely corrections), or the calibration period in the case that calibration is required.

The similarity coefficient 815 is a coefficient for evaluating the similarity of each device 102, each pipe 103, or each sensor 104. The similarity coefficient 815 is described in detail later on.

The relation schema 816 contains a relation name 817 and 0 or one or more schema ID818. The relation name 817 is the same as the relation name 808 and indicates the type of relation with other devices 102, pipe 103 or sensors 104. The schema ID818 indicates an identifier for the schema information 810 of a device 102, pipe 103, or sensor 104 connected to a device 102, pipe 103, or sensor 104 corresponding to the schema ID803.

If the schema ID803 for example indicates an identifier for the schema information 810 for the motor, then the schema ID818 shows an identifier for the schema information 810 for the cable, and the attribute name 817 contains a character string for “connection” showing a connected (state). Also if the schema ID803 shows for example an identifier for the schema information 810 for the turbine, then the schema ID818 shows an identifier for the schema information 810 for the pipe, and the attribute name 817 contains a character string for “position separated by 10 centimeters” showing positioning separated by a fixed distance.

The relation schema 816 contains a schema ID818 showing another schema information 810, and in the aforementioned example includes the schema ID818 for a specified pipe.

The device information 702 and the sensor information 703 are stored beforehand by the administrator in an examination server 107.

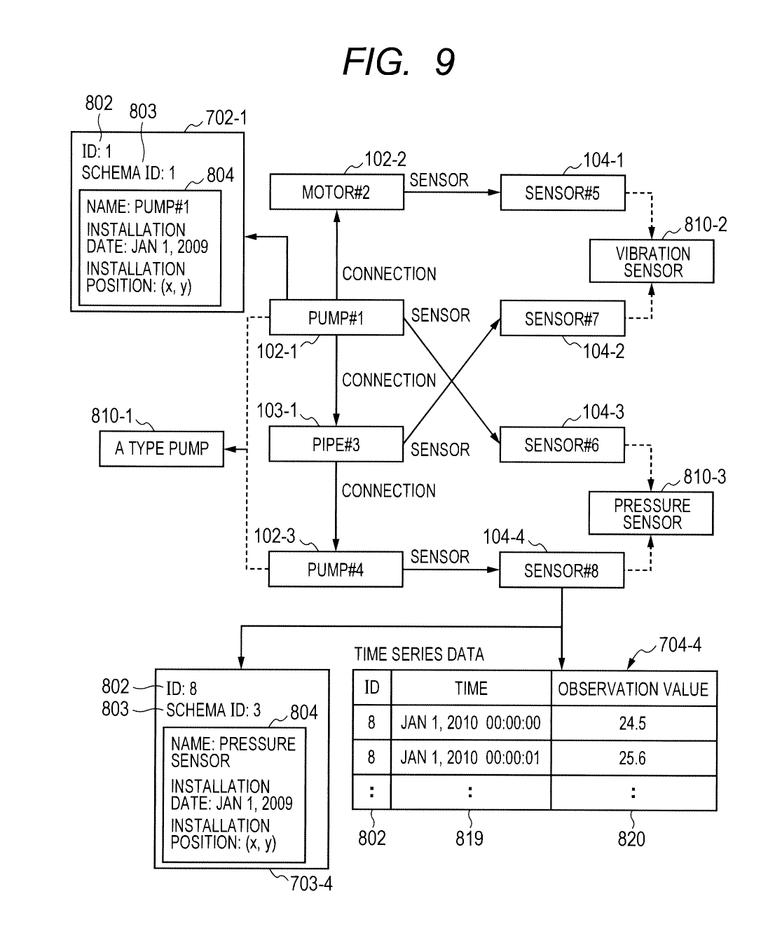

FIG. 9 is a descriptive drawing showing a specific example of the device information 702 and sensor information 703 of the first embodiment of the present invention.

The device 102 shown in FIG. 9 is a pump #1 (102-1), a motor #2 (102-2), and a pump #4 (102-3). The pipe 103 is a pipe #3 (103-1). The sensor 104 is a sensor #5 (104-1), a sensor #6 (104-2), a sensor #7 (104-3), and a sensor #8 (104-4).

The pump #1 (102-1) and the pipe #3 (103-1) are connected, and the pump #1 (102-1) and the motor #2 (102-2) are connected. Also, the pipe #3 (103-1) and the pump #4 (102-3) are connected.

The sensor #6 (104-2) is connected to the pump #1 (102-1), and the sensor #5 (104-1) is connected to the motor #2 (102-2). Also, the sensor #7 (104-3) is connected to the pipe #3 (103-1), and the sensor #8 (104-4) is connected to the pump #4 (102-3).

The device information 702 corresponding to the pump #1 (102-1) is the device information 702-1. The devices 102 shown in FIG. 9 correspond to each of the device information 702.

The sensor information 703 corresponding to the sensor #8 (104-4) is the sensor information 703-4. The pipe 103 shown in FIG. 9 corresponds to each of the sensor information 703. Moreover, the sensor #8 (104-4) corresponds to the time-series data 704-4. The ID802 for the time-series data 704-4 is the same as the ID802 shown in the sensor information 703-4. The sensor information 703 and the time-series data 704 for the pipe 103 correspond to the pipe 103 as described above.

The relation 807 is not shown for the device information 702-1 and the sensor information 703-4 shown in FIG. 9.

The pump #1 (102-1) and pump #4 (102-3) correspond to the schema information 810-1 showing the schema information 810 for the same A type pump. In other words, the schema ID803 for the device information 702-1 of pump #1 (102-1), and the schema ID803 for the device information 702 of pump #4 (102-3) both show the schema information 810-1.

The sensor #5 (104-1) and sensor #7 (104-3) are both a sensor 104 for measuring the vibration in the motor and the pipe; and correspond to the schema information 810-2 as the schema information 810 for the vibration sensor. Further, the sensor #6 (104-2) and the sensor #8 (104-4) are both a sensor 104 for measuring the pressure in the pump; and correspond to the schema information 810-3 as the schema information 810 for the pressure sensor.

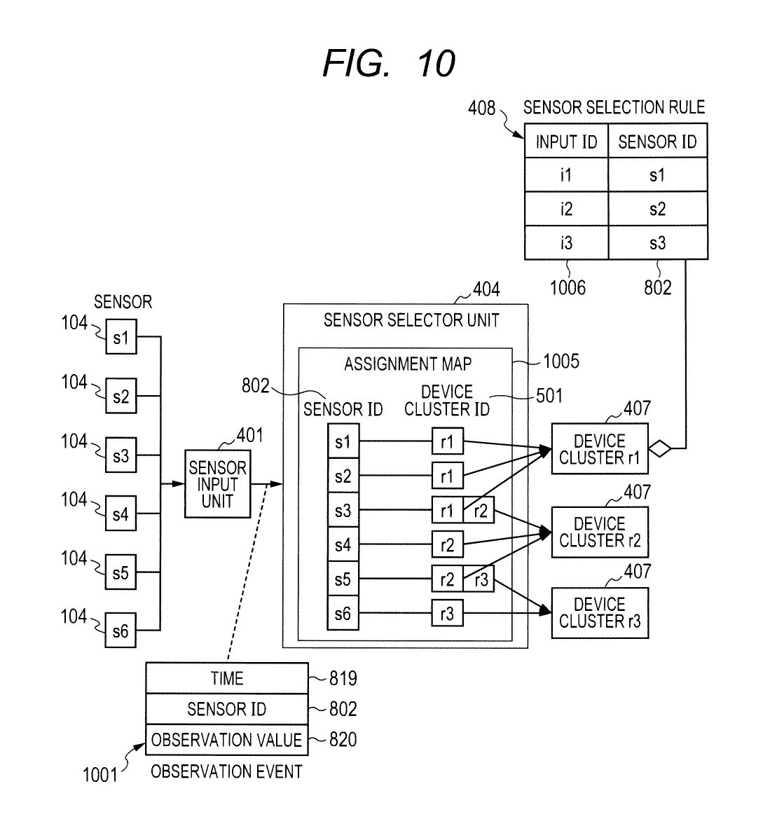

FIG. 10 is a descriptive drawing showing the structure of the sensor selector unit 404 and the sensor selection rule 408 in the first embodiment of the present invention. The structure shown in FIG. 10 corresponds to step 511 and step 512 shown in FIG. 5.

The observation values measured by the plural sensors 104 are sent to the sensor selector unit 404 by way of the sensor input unit 401. The sensor 104 sends the observation values by sending the observation event 1001 containing the observation values for sending, to the sensor selector unit 404. The sensor ID802 for each of the sensors s1-S6 are here assigned in advance to each sensor 104.

The observation event 1001 includes the time 819 when the observation values measured, the sensor ID802, and the observation value 820. The observation event 1001 corresponds to the time-series data 704. The device cluster 407 includes the sensor selection rule 408 just as already described. The observation event 1001 holds the same data as the time-series data 704. The examination server 107 stores the observation event 1001 as the time-series data 704 during storing of the observation event 1001 in the RDB306.

The sensor selector unit 404 retains an assignment map 1005 for assigning the observation events 101 sent from the sensor 104 according to the device cluster 407. The assignment map 1005 is a map for linking the sensor ID802 and the device cluster 501. The assignment map 1005 may for example be a database that holds a key value structure for utilizing the sensor ID802 as a key for retaining the plural device cluster ID501 as values, and moreover contains a hash map structure.

The sensor selection rule 408 includes the input ID1006 and sensor ID802, and assigns an input ID1006 to the sensor ID802. The input ID1006 is an identifier assigned to the sensor ID802 for selecting the observation value 820 to input to the function required for the processing, during the processing of the observation value 820 in the observation value processor unit 405. The sensor selector unit 404 is capable of selecting which observation value 820 for the sensor 104 to set as which input values for the function.

The observation event 1001 sent from the sensor 104 is assigned by way of the sensor selector unit 404 to the device cluster 407 for each sensor ID802. The sensor selector unit 404 assigns the input ID1006 to the observation events 1001 sent by way of the sensor 104 shown by the sensor ID802 according to the sensor selection rule 408 contained in the device cluster 407.

Here there are cases when one sensor ID802 is assigned to plural device clusters ID501. In the assignment map 1005, for example, the observation event 1001 whose sensor ID 802 are “s1”, “s2”, and “s3” are assigned to the device cluster 407 whose device cluster ID501 are “r1”.

The observation event 1001 whose sensor ID802 are “s3”, “s4”, “s5” are assigned to the device cluster 407 whose device cluster ID501 is “r2”. The observation event 1001 whose sensor ID802 is s3 are therefore assigned to the device cluster 407 whose device cluster ID501 are r1 and r2. In this case, the sensor selector unit 404 copies the observation event 1001 into two items, and assigns the input ID1006 to each of the copied observation events 1001.

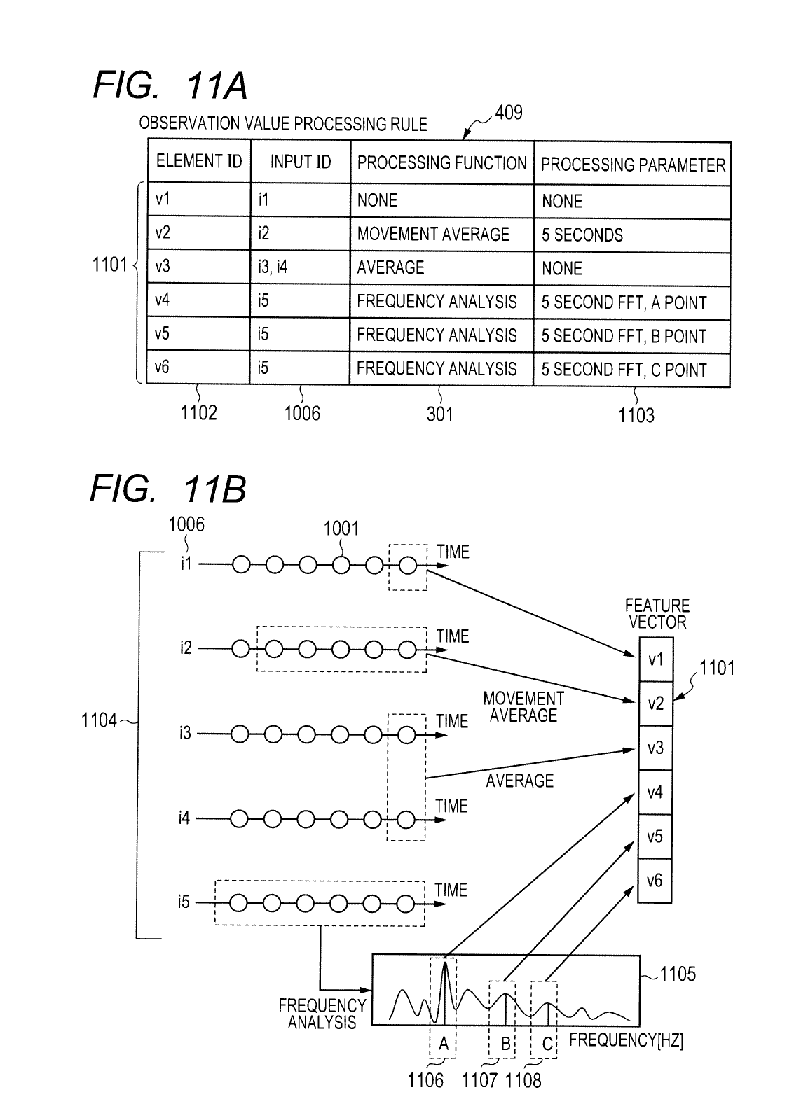

FIG. 11A is a descriptive drawing showing an observation value processing rule 409 of the first embodiment of the present invention.

The observation value processing rule 409 includes an element ID1102, an input ID1006, a processing function 301 and a processing parameter 1103. The observation value processing rule 409 is present in each device cluster 407 as already described.

The element ID1102 is an identifier for identifying the elements contained in the feature vector 1101. The input ID1006 is an identifier assigned by the sensor selector unit 404 to the observation event 1001. The elements contained in the element ID1102 are hereafter given as the element v1, element v2, . . . , and the element Vn.

The processing function 301 is a function for processing the observation value 820 among the observation events 101. The processing function 301 shown in FIG. 11A is shown by way of a character string but the processing function 301 may include formulas, and also include parameters for the readout by the formula. The processing parameter 1103 is a parameter for inputting the function shown by way of the processing function 301.

Plural inputs ID1006 are sometimes assigned to the element ID1102. This arrangement allows inputting observation values 820 that were measured by plural sensors 104 to the function shown in the processing function 301.

FIG. 11B is a descriptive drawing showing an example of processing by the observation value processor unit 405 in the first embodiment of the present invention. The processing shown in FIG. 11B corresponds to step 513 in FIG. 5.

In the example shown in FIG. 11B, the circles along the time axis show the observation events 1001, and show the observation event 1001 accumulated along the time axis. In the time axis shown in FIG. 11B, the time is newer towards the right side of the axis. The observation events 1001 accumulated according to the time series are given the collective name of input data 1104.

The element v1 among the feature vectors 1101, indicates an input ID1006 that is i1 for the observation value processing rule 409, and the processing function 301 shows a “none”. The observation value processor unit 405 therefore stores the observation value 820 in the element v1 unchanged, and without processing the observation value 820 in the observation event 1001 where input ID1006 is i1.

The element v2 among the feature vectors 1101, indicates an input ID1006 that is i2 for the observation value processing rule 409, the processing function 301 shows a “movement average”, and the processing parameter 1103 shows “5 seconds”. The observation value processor unit 405 therefore calculates an average of observation values 820 over 5 seconds, or in other words, calculates the movement average based on the observation value 820 measured over a five second period by the sensor 104 corresponding to i2. The observation value processor unit 405 then stores the calculated movement average in the element v2.

When the processing parameter 1103 shows “5 seconds”, then the observation value 820 utilized for the calculation may also be an observation value 820 for the observation event 1001 received over a five second period by the observation value processor unit 405. Therefore, even if the processing parameter 1103 shows “5 seconds” this display does not signify that there are five observation events 1001.

The element v3 among the feature vectors 1101, indicates an input ID1006 that is i3 and i4 for the observation value processing rule 409, and the processing function 301 shows “average”. The observation value processor unit 405 therefore calculates the average value for the observation value 820 measured by the sensor 104 corresponding to i3 and the sensor 104 corresponding to i4; or in other words, calculates an average for the observation value 820 per the sensor 104 at that same time. The observation value processor unit 405 then stores the calculated average in the element v3.

The element v4 among the feature vectors 1101, indicates an input ID1006 that is i5 for the observation value processing rule 409, and the processing function 301 shows “frequency analysis”, and the processing parameter 1103 shows “5 second FFT, A point”.

The observation value processor unit 405 therefore makes an FFT (Fast Fourier Transform) or in other words performs a frequency analysis based on the observation value 820 measured over a five second period by the sensor 104 corresponding to i5. Moreover, the “A point” indicates an optional frequency, and among the results 1105 obtained by frequency analysis, the amplitude 1106 for the A point is stored in the element v4.

The processing function 301 for the element v5 among the feature vector 1101 and element v6 among the feature vector 1101 also indicates “frequency analysis” for the observation value processing rule 409, and the processing parameter 1103 shows “5 second FFT” the same as the feature vector 1101 showing “v4”. However, a “B point” is also included in the processing parameter 1103 in the element v5 per the observation value processing rule 409; and “C point” is included in the processing parameter 1103 in the element v6 per the observation value processing rule 409.

The observation value processor unit 405 therefore stores the amplitude 1107 at the B point in element V5 and stores the amplitude 1108 for the C point in the element v6 from among the frequency analysis results 1105 implemented based on the observation value 820 measured over a five second period by the sensor 104 corresponding to i5, and the input data 1104 for i5.

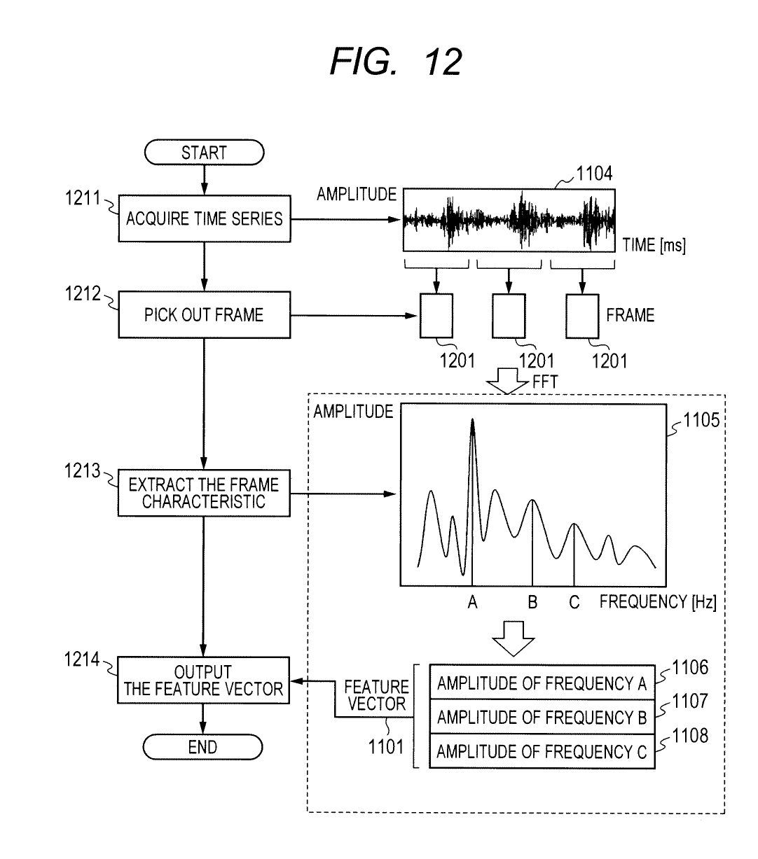

FIG. 12 is a flow chart showing frequency analysis by the observation value processor unit 405 of the first embodiment of the present invention. Detailed information on the frequency analysis in FIG. 11 is described below.

First of all, the observation value processor unit 405 acquires the input data 1104 (step 1211). The input data 1104 is a plurality of observation events 1001 (time-series data 704) accumulated on a time-series base in the examination server 107. The observation value processor unit 405 sub-divides the acquired input data 1104 into a frame 1201 at time intervals (5 seconds, in FIG. 11B) specified by the processing parameter 1103(step 1212), and converts each frame 1201 into frequency components by FFT and so on (step 1213).

The observation value processor unit 405 moreover extracts each frequency amplitude specified by the processing parameter 1103 from among the results 1105 obtained by FFT and so on, and outputs the extracted frequency amplitude as the feature vector 1101.

The event 1305 of the present embodiment is described next.

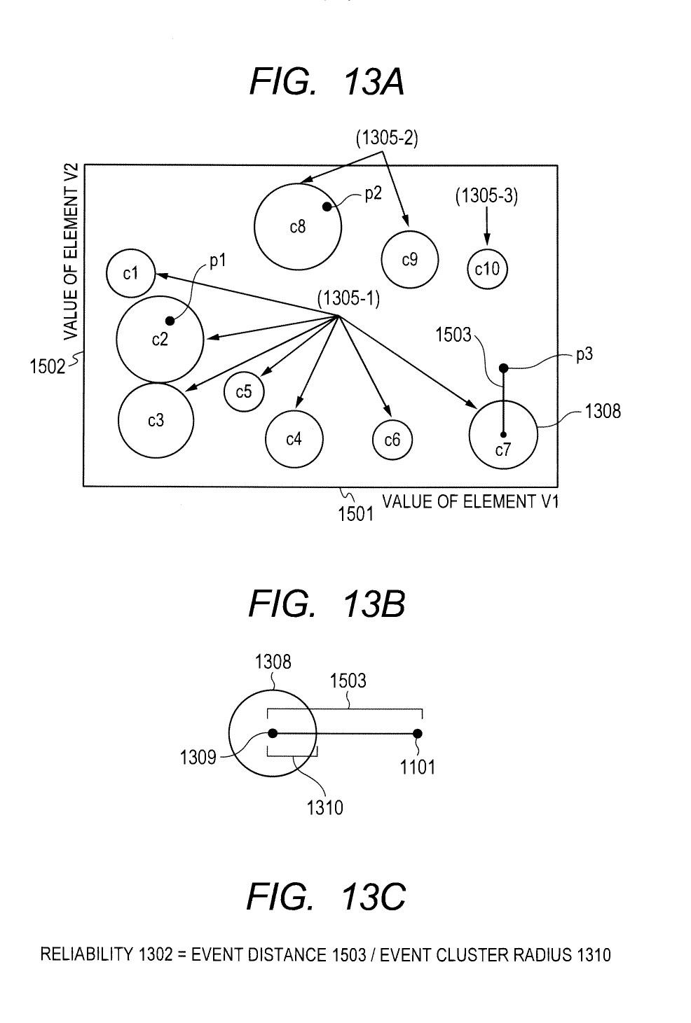

FIG. 13A is a descriptive drawing showing an example of distribution of the event 1305 in the first embodiment of the present invention.

The event 1305 here indicates damage likely to occur in the device 102 or the pipe 103; or that the device 102 or the pipe 103 is in a normal state. Specifically, the event 1305 shows events such as, “fracture has occurred” or “pressure is rising, creating explosion hazard”, or “safe condition”, etc.

The example in FIG. 13A shows how the events 1305 are distributed when there are two elements for the feature vector 1101. The two elements are shown by the element V1 and the element V2. In the drawing shown in FIG. 13A, the horizontal axis is the value 1501 for element V1 and the vertical axis is the value 1502 for element V2.

The horizontal axis and vertical axis shown in FIG. 13A are each feature spaces or in other words are dimensions. The feature spaces in the present embodiment are the same in number as the number of feature vector 1101 elements.

The event 1305 is shown in FIG. 13A by the event A (event 1305-1), the event B (1305-2) and the event C (event 1305-3).

The event cluster 1308 in FIG. 13A is the range of values of the feature vector 1101 that the event 1305 occurred in the past and indicates the range of the occurred element V1 value 1501 and element V2 value 1502 judged as extremely likely that the event 1305 occurs.

The event A (event 1305-1) includes an event cluster 1308 shown by the range c1-c7. The event B (event 1305-2) includes an event cluster 1308 shown by the range of c8 and c9. The event C (event 1305-3) includes the event cluster 1308 shown by the range of c10.

The feature vector 1101 value is shown by p1-p3 in FIG. 13A. If the feature vector 1101 is the p1 contained in the event cluster c2, then in FIG. 13A there is an extremely high probability that the event A (event 1305-1) will occur in the device 102 or pipe 103 connected to the sensor 104 corresponding to the feature vector 1101. If the feature vector 1101 is p2, then in FIG. 13A there is an extremely high probability that the event B (event 1305-2) will occur in the device 102 or pipe 103 connected to the sensor 104 corresponding to the feature vector 1101.

If the feature vector 1101 is p3, then in FIG. 13A there is a high probability that no event 1305 has occurred in the device 102 or pipe 103 connected to the sensor 104 corresponding to the feature vector 1101.

The event distance 1503 is the distance between the feature vector 1101 and the center-of-gravity of each event cluster 1308.

FIG. 13B is a descriptive drawing showing the relation between the event cluster 1308 and the feature vector 1101 in the first embodiment of the present invention.

The event cluster center-of-gravity 1309 is the center-of-gravity of the event cluster 1308. The event cluster 1308 is a hyper sphere, or namely is sphere in a multidimensional feature space. The event cluster radius 1310 is the radius of the event cluster 1308 whose center is the event cluster center-of-gravity 1309.

The distance between the event cluster center-of-gravity 1309 and the feature vector 1101 is the same as the event distance 1503 that was already described. The closer that the feature vector 1101 approached the center-of-gravity of the event cluster 1308, the higher the probability that the event 1305 corresponding to the event cluster 1308 will occur in the device 102 or the pipe 103 connected to the sensor 104 corresponding to the feature vector 1101.

FIG. 13C is a descriptive drawing showing the (math) function for calculating the reliability 1302 in the first embodiment of the present invention.

The reliability 1302 shows the possibility that no event 1305 will occur. The reliability 1302 is calculated by dividing the event distance 1503 by the event cluster radius 1310. The larger the value of the event distance 1503 and the smaller the value of the event cluster radius 1310, the higher the reliability 1302 value becomes, and the higher the possibility that no event 1305 will occur.

Also, the lower the value of the event distance 1503 and the higher the value of the event cluster radius 1310, the smaller the reliability 1302 value becomes, and the lower the possibility that the event cluster 1308 will occur. In other words, the event distance 1503 becomes smaller than the event cluster radius 1310, and if the reliability 1302 becomes a value lower than 1, then there is a high possibility that the event 1305 will occur.

Conversely, the higher the event cluster radius 1310, and the lower the event distance 1503, the lower the reliability 1302 value becomes. The smaller the reliability 1302 value the higher the possibility that the event cluster 1308 will occur.

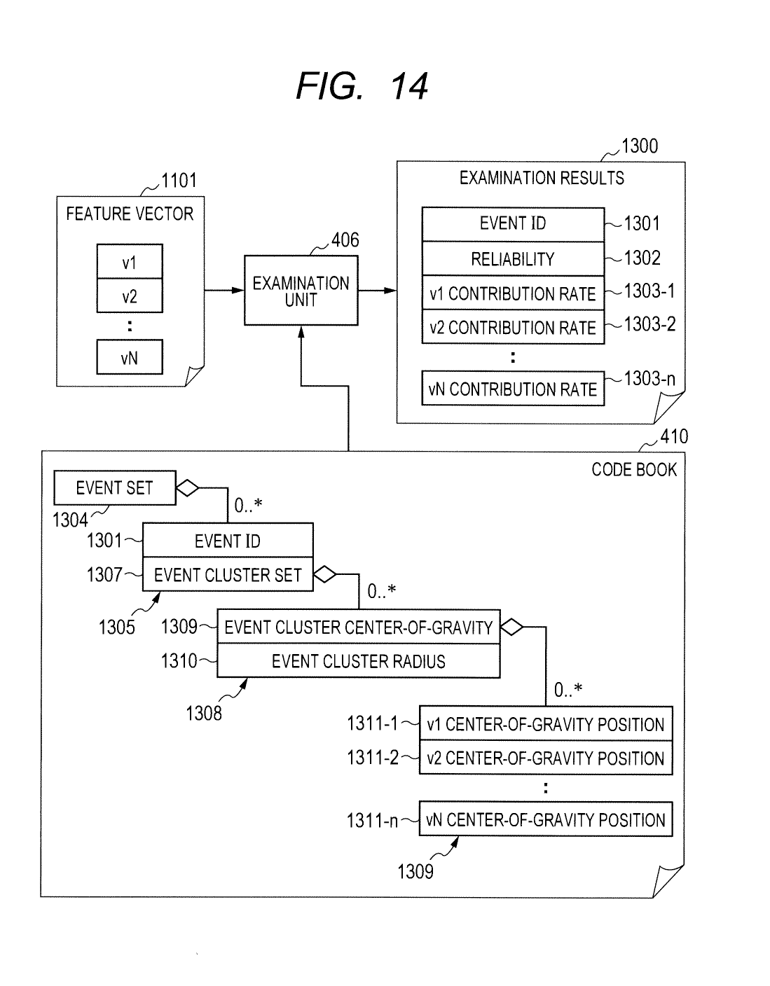

FIG. 14 is descriptive drawing showing the input/output data for VQC by the examination unit 406 of the first embodiment of the present invention.

The feature vector 1101 generated by the observation value processor unit 405 is sent to the examination unit 406. The examination unit 406 generates an examination results 1300 by utilizing the codebook 410 contained in the feature vector 1101, and the device cluster 407.

The examination results 1300 include the event ID1301, the reliability 1302, and the contribution rate 1303. The event 1D1301 is an identifier showing the unique event 1305. The reliability 1302 is the possibility calculated by using the formula shown in FIG. 13C, and the event 1305 shown by the event ID1301 might not occur in the device 102 or the pipe 103 connected to the sensor 104 corresponding to the feature vector 1101.

The contribution rate 1303 contained (contribution rate 1303-1 through contribution rate 1303-n) in each element of the feature vector 1101 is a numerical value showing the extent of the contribution the elements apply to the examination results 1300.

The contribution rate 1303 is found by calculating each of the distance between the each element contained in the feature vector 1101, and the center-of-gravity of the event 1305; and then calculating the percent that the calculated distances between the center-of-gravity of event 1305 and each element occupies in the total sum of the distance between the event 1305 center-of-gravity and all elements. The contribution rate 1303 may also be standardized so that summing all of the contribution rates 1303 attains a 1.

The feature vector 1101 for p3 shown in FIG. 13A is contained in the event cluster 1308 in the value for element V1 but is not contained in the event cluster 1308 in the value for element V2. Therefore when calculating the examination results 1300, the element V2 contributes more to the examination results 1300 so that the contribution rate 1303 is high.

The code book 410 includes the event set 1304, the event 1305, the event cluster 1308 and the event cluster center-of-gravity 1309. The event set 1304 includes 0 or one or more events 1305. The code book 410 contains information placed in advance relating to the event 1305.

The event 1305 includes the event 1131301 and the event cluster set 1307. The event 1305 includes 0 or one or more event clusters 1308.

The event cluster 1308 includes the event cluster center-of-gravity 1309 and the event cluster radius 1310. The event cluster 1308 includes 0 or one or more event cluster center-of-gravity 1309.

The event cluster center-of-gravity 1309 includes the center-of-gravity (position) 1311. The event cluster center-of-gravity 1309 includes a number (quantity) of elements for the feature vector 1101, or namely a number (quantity) of center-of-gravity positions 1311-1 through 1311-n for the feature space (dimension).

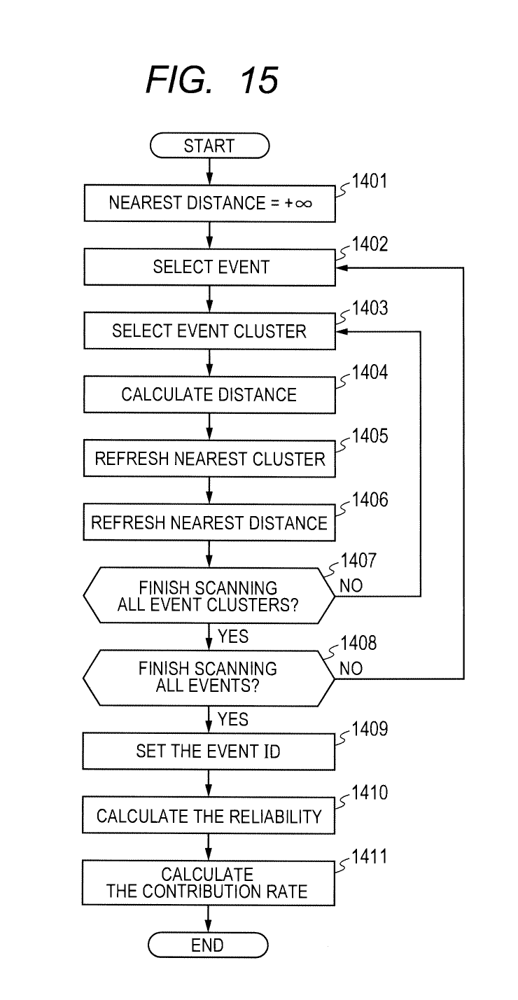

FIG. 15 is a flow chart showing the VQC by the examination unit 406 of the first embodiment of the present invention.

When the feature vector 1101 is sent from the observation value processor unit 405, the examination unit 406 stores a numerical value infinity for the nearest distance to initialize (step 1401). This nearest distance is a parameter. The examination unit 406 then selects one event 1305 from the event 1305 contained in the code book 410 (step 1402), and selects an event cluster 1308 contained in the event 1305 selected in step 1402 (step 1403).

The examination unit 406 compares the event cluster center-of-gravity 1309 for the event cluster 1308 selected in step 1403, with the feature vector 1101 sent from the observation value processor unit 405, and calculates the distance (step 1404). The function utilized when calculating the distance is shown below

$$\sqrt{{\sum }_{t ∈ All attributes}^{ } {( {V}_{t} - {C}_{t} )}^{2}} \qquad [ Formula 1 ]$$

Here, Vt is a value for the element of the feature vector 1101. Also, Ct is a value of the center-of-gravity (position) 1311 for the event cluster 1308. The t in the formula indicates one element among all of the feature spaces (dimensions) and is a number from 0 to the feature space.

The examination unit 406 then stores the event cluster 1308 with the shortest distance among the calculated distance and the distances calculated up to then into the nearest cluster (step 1405). The nearest cluster is a parameter. The shortest distance among the distances calculated up to then and step 1404 is stored in the shortest distance (step 1406).

The examination unit 406 then decides whether or not the distance with all the event clusters 1308 was calculated (step 1407), and returns to step 1403 if decided the distance with all the event clusters 1308 was not calculated. If the distance for all the event clusters 1308 was calculated then the examination unit 406 decides whether or not the distance for the event clusters 1380 included in all the event 1305 was calculated or not (step 1408), and returns to step 1402 if decided that the distances for the event clusters 1308 in all of the events 1305 were not calculated.

If decided that the distance for the event clusters 1308 contained in all the event cluster 1305 was calculated, then the examination unit 406 acquires the event ID 1301 contained in the event clusters 1308 shown by the nearest cluster, and stores the acquired event ID 1301 in the event ID 1301 of the examination results 1300 (step 1409). Then the reliability 1302 is calculated by subtracting the distance calculated in step 1404 from the event cluster 1308 shown by the nearest cluster (step 1410).

The examination unit 406 further calculates the contribution rate 1303 (step 1411) based on the feature vector 1101, the event cluster radius 1310, and the center-of-gravity position 1311, and outputs the examination results 1300.

The above information described the processing up through step 514 in FIG. 5.

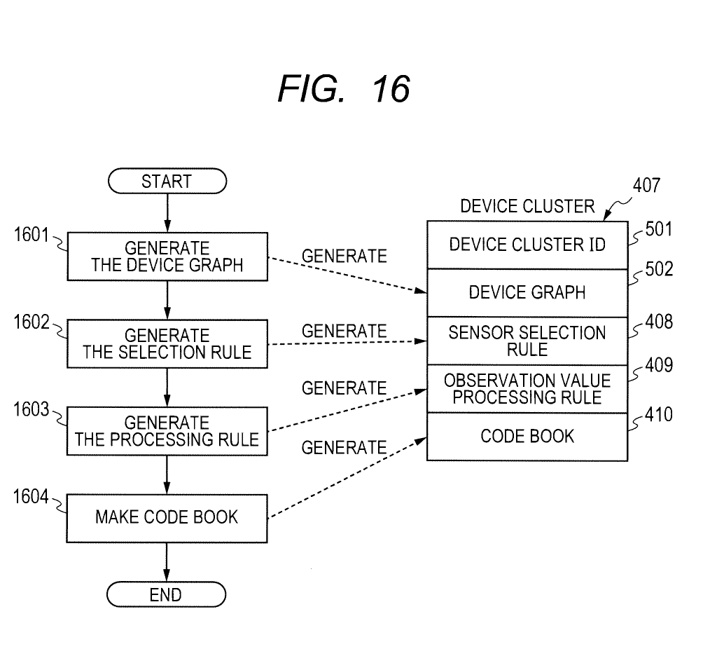

FIG. 16 is a flow chart showing an overview of the processing for generating the device cluster 407 in the first embodiment of the present invention.

The selection rule maker unit 412 generates a new device graph 502 when a new device 102 or pipe 103 has been added to the plant 101 (step 1601), and generates a sensor selection rule 408 (step 1602). The processing rule maker unit 413 then generates an observation value processing rule 409 (step 1603). That examination rule maker unit 414 then generates a code book 410 (step 1604).

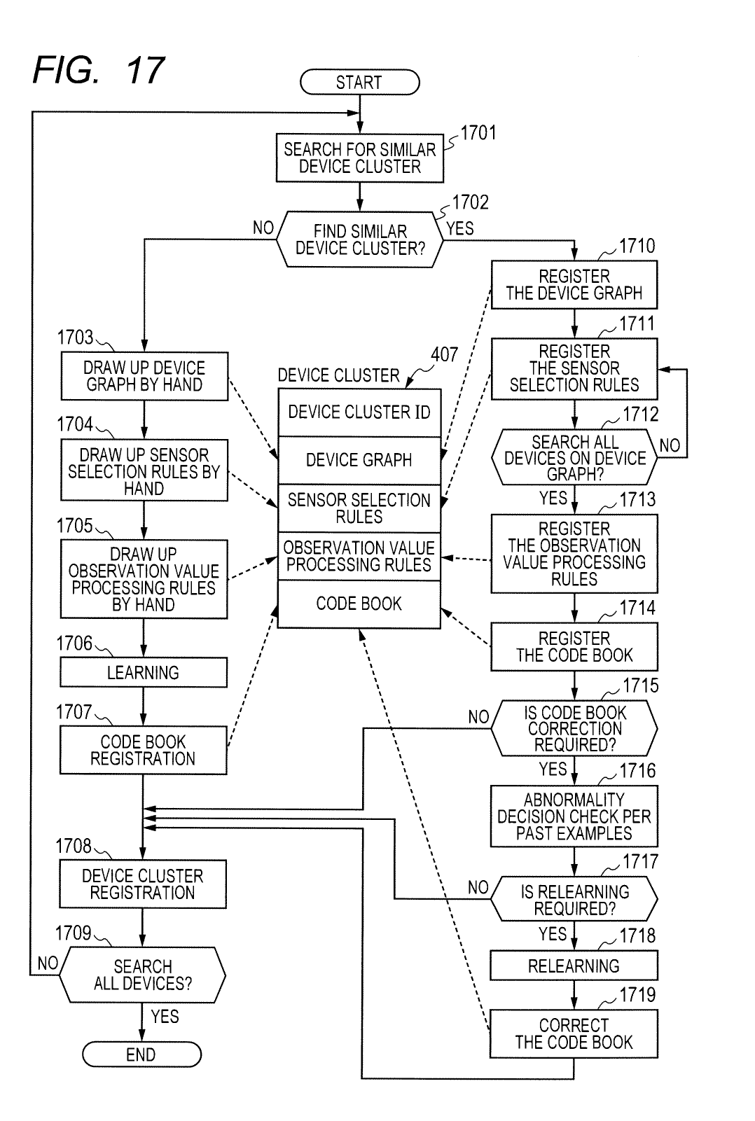

FIG. 17 is a flow chart showing in detail the processing for generating the device cluster 1407 in the first embodiment of the present invention.

If a new device 102 or pipe 103 was added to the plant 101, then the examination server 107 searches device clusters 407 having a device graph 502 similar to the structure of the new device 102 or pipe 103 (step 1701). The procedure for searching for a device cluster 407 containing device graph 502 is described later on. The examination server 107 then decides whether or not a similar device cluster 407 was found (step 1702). If the examination server 107 does not find a similar device cluster 407, then the administrator inputs a device cluster 407 via the examination server 107 by way of the steps from 1703 onwards.

The administrator makes a device graph 502 based on the design documents (step 1703), makes a sensor selection rule 408 (step 1705), makes an observation value processing rule 409 (step 1705), and inputs each of these rules to the examination server 107.

The administrator then has the learning unit 304 of examination server 107 learn (step 1706) the actual events that occurred in specified periods such as a half-year or one year through the usual tasks performed by the new device 102 or pipe 103. Namely in step 1706, the learning unit 304 acquires the observation values occurring at specified intervals and learns the contents of the event corresponding to the acquired observation values through entries made by the administrator.

The examination server 107 makes the code book 410 by the learning unit 304 shown in FIG. 3 based on the observation values acquired in step 1706, and the contents of the events input by the administrator. The examination server 107 then itself inputs the code book 410 that was made in step 1706 (step 1707).

The examination server 107 then registers (step 1708) the device cluster 407 by assigning the device clusters ID501 to each of the information made in the steps 1703-1707.

The examination server 107 then judges whether or not a device cluster 407 was made for all the new devices 102 or pipes 103 (step 1709). If there are devices 102 or pipes 103 for which a device cluster 407 was not made, then the processing returns to step 1701. If a device cluster 407 was made for all the new devices 102 or pipes 103 then the processing ends.

The processing from step 1709 onwards may be executed in parallel with the processing from step 1706 since a specified time actually elapses in step 1706.

When decided in step 1702 that a similar device cluster 407 was found by the examination server 107, the selection rule maker unit 412 stores the similar device graph 502 for the device cluster 407 found in step 1701, into the device graph 502 for the device cluster 407 of the new device 102 or the pipe 103 (step 1710).

The selection rule maker unit 412 further stores the sensor selection rule 408 for the similar device cluster 407 into the sensor selection rule 408 for the device cluster 407 of the new device 102 or pipe 103 (step 1711). A decision is also made on whether or not all the sensor selection rules 408 corresponding to the device 102 or pipe 103 shown in the device graph 502 were stored (step 1712) and if there are device graphs 502 in which the sensor selection rules 408 were not stored then the processing returns to step 1711.

If all of the sensor selection rules 408 corresponding to device 102 or pipe 103 shown in the device graph 502 were stored, then the processing rule maker unit 413 stores the observation value processing rule 409 of the similar device cluster 407 into the observation value processing rule 409 for the device cluster 407 of the new device 102 or pipe 103 (step 1713). Also a code book 410 for the similar device cluster 407 is stored in the code book 410 of the device cluster 407 of the new device 102 or pipe 103 (step 1714).

The examination server 107 next decides whether or not correction of the code book 410 stored in step 1714 is required (step 1715). The examination server 107 decides whether or not correction of the code book 410 is required by way of instructions entered by the administrator. The administrator judges whether or not there are records in the code book 410, and enters the decision results in the examination server 107.

When decided in step 1715 that no correction of the code book 410 is needed, the examination server 107 shifts to step 1708, and registers the device cluster 407.

If decided in step 1715 that correction of the code book 410 is needed, then the examination server 107 diagnoses the time-series data 704 in cases that occurred in the past by way of the newly generated device cluster 407. The examination server 107 then outputs the obtained examination results to an output device to allow confirmation by the administrator (step 1716).

The administrator or other party checks the examination results and decides if relearning is required or not, and inputs information showing whether relearning is necessary or not to the examination server 107.

The examination server 107 acquires the information input by the administrator showing whether relearning is necessary or not and decides whether or not changing the device cluster 407 by relearning is needed (step 1717). If decided in step 1717 that relearning is not necessary then the examination server 107 shifts to step 1708 and registers the device cluster 407.

If decided in step 1717 that relearning is necessary, then the examination server 107 makes the relearning unit 305 perform the relearning at specified periods such as a half-year or one year (step 1718). The relearning unit 305 performs the relearning by refreshing the event cluster center-of-gravity 1309 and event cluster radius 1310 based on the event cluster 1305 that occurred in a specified period.

The examination server 107 corrects the code book 410 of the new device cluster 407 based on the results from step 1718 (step 1719), and shift to step 1708.

The examination server of the present invention is capable of applying the examination rule for a similar device cluster 407 to the new device cluster 407 by performing step 1710 through step 1719. Moreover, even more flexible examination rules can be applied to the new device cluster 407 by relearning, etc.

The examination server 107 of the present embodiment searches similar device clusters 407 by way of similar device graphs 502 or in other words, searches the connection relations of similar devices 102 and so on from among existing devices 102, etc.

In the event of new construction at the plant 101, or addition of the device 102 or the pipe 103, then the examination server 107 acquires the device cluster 407 corresponding to devices 102 or pipes 103 having a connection relation similar to the new device 102 or the pipe 103 connection relation, among device clusters 407 corresponding to existing devices 102 or pipes 103; and generates a device cluster 407 corresponding to the new device 102 or pipe 103 based on the acquired device cluster 407.

In the following description, the device 102 or pipe 103 are given the collective name of node.

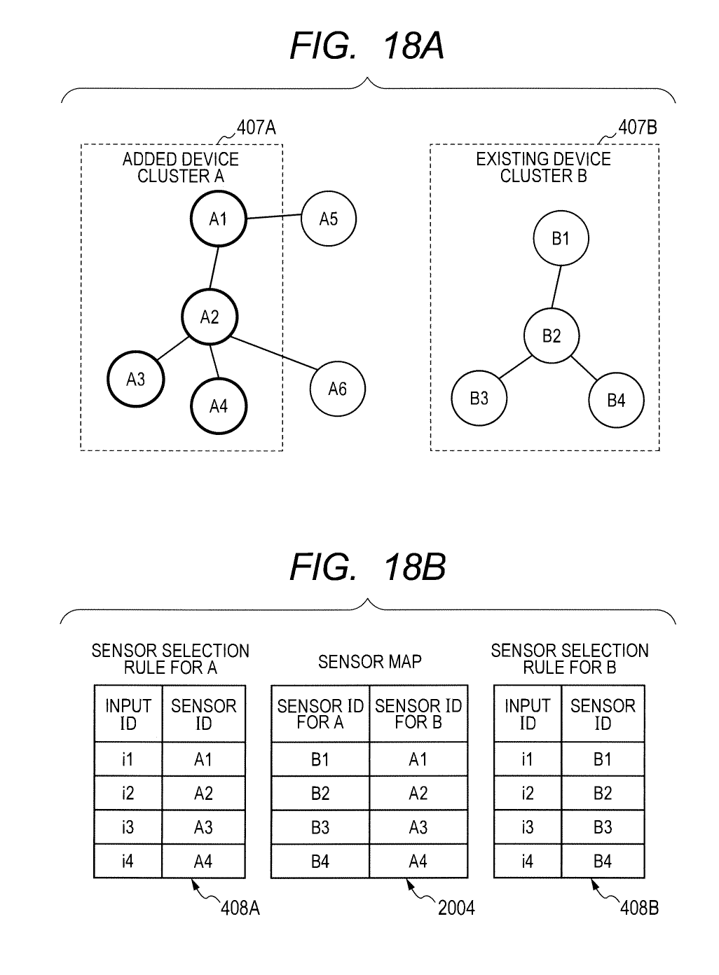

FIG. 18A is a descriptive drawing showing a specific example for acquiring similar device graph 502 in the first embodiment of the present invention.

FIG. 18A shows the case where adding a new node A (nodes A1-A6) to a plant 101 containing the existing node B (nodes B1-B4). When the device graph 502 of the nodes A1-A4 among the added nodes A1-A6 are similar to the device graph 502 of the existing (nodes) B1-B4, a device cluster 407A corresponding to the nodes A1-A6 is generated based on the device cluster 407B containing the device graph 502 of the nodes B1-B4.

FIG. 18B is a descriptive drawing showing the generation of a sensor selection rule 408 in the first embodiment of the present invention.

In step 1701 of FIG. 7, when the device cluster 407 corresponding to the nodes A1-A4 shown in FIG. 18A is searched for a device cluster 407 similar to the device cluster 407 corresponding to existing nodes B1-B4, the selection rule maker unit 412 in step 1711 of FIG. 17, generates a new sensor selection rule 408A based on the sensor selection rule 408B contained in the device cluster 407 searched in the step 1701.

The selection rule maker unit 412 first of all makes a combination of nodes A1-A4, and nodes B1-B4 resembling each of the nodes A1-A4, from the results searched in step 1701. The selection rule maker unit 412 then generates a sensor map 2004 by substituting each node the ID802 of the sensors 104 connected to each node.

The selection rule maker unit 412 further generates a sensor selection rule 408A for the new nodes A1-A4, based on the sensor map 2004 and the sensor selection rule 408B corresponding to the existing nodes B1-B4.

The procedure for acquiring a similar device graph 502 in order to search for a similar device cluster 407 in step 1701 of FIG. 17 is shown next.

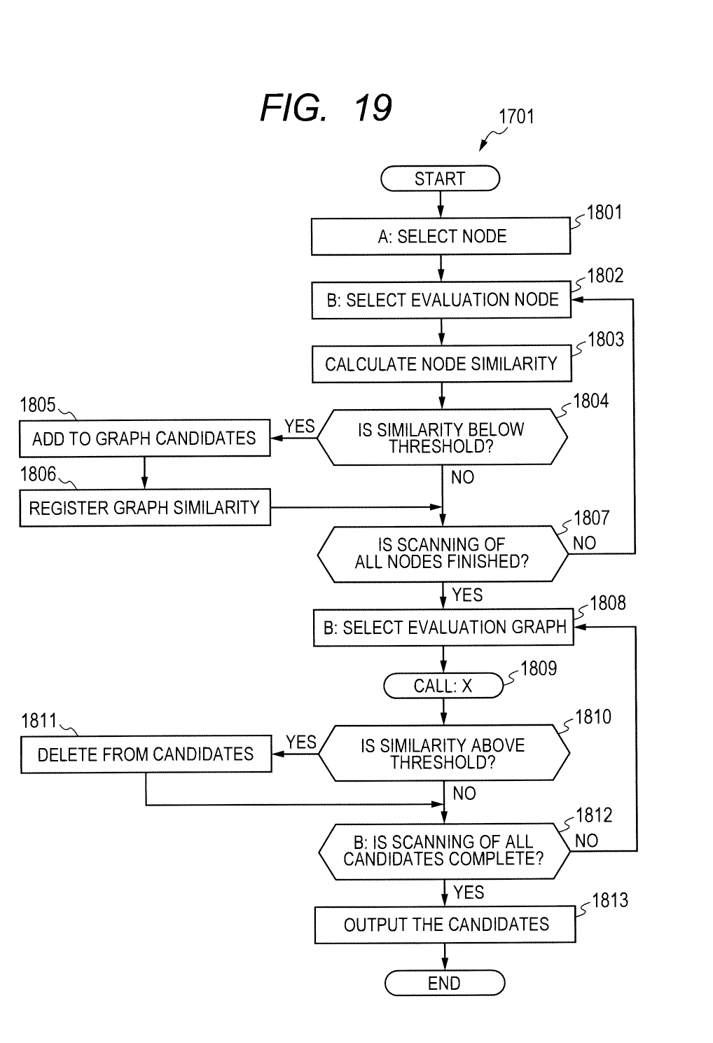

FIG. 19 is a flow chart showing the procedure for acquiring a similar device graph 502 in the first embodiment of the present invention.

The processing shown in FIG. 19 is equivalent to step 1701 in FIG. 17. The following description is for an example in the case where the nodes A1-A4 were added as shown in FIG. 18A.

The similar graph search unit 302 contained in the examination server 107 selects one among the new nodes A1-A4 (step 1801) when the new nodes A1-A4 have been added to the plant 101. The node selected in step 1801 is described as node A.

One (node) among the existing nodes B1-B4 is selected an object for evaluation (step 1802). The node selected in step 1802 is described as node B.

After step 1802, the similar node search unit 303 calculates the (degree of) similarity of the node B selected in step 1802 and the node A selected in step 1801 (step 1803). The (degree of) similarity is defined by finding values more than zero and setting the smaller one as similar. The method for calculating the similarity is described later on.

The similar graph search unit 302 then decides (step 1804) whether the (degree of) similarity calculated in step 1803 is at or below a pre-established threshold value. If the calculated similarity is below the threshold value, then the node A and the node B are similar so that the device graph 502 contained in node B is added to the similar device graph (step 1805).

The similar graph search unit 302 stores the similarity calculated in step 1803 in the graph similarity of RDB306 (step 1806). The similar device graph and the graph similarity are a storage region stored in the RDB306.

If the similarity calculated in step 1804 is higher than the threshold value, or after step 1806, then the similar graph search unit 302 decides whether the existing nodes B1-B4 were all selected or not (step 1807). If decided that not all of the existing nodes B1-B4 were selected then the similar graph search unit 302 returns to step 1802.

The similar graph search unit 302 selects node B as a reference for comparing with Node A per the processing through step 1807.

If decided that all of the existing nodes (B1-B4) were selected in step 1807, then the similar graph search unit 302 selects one existing device graph 502 as an object for evaluation among similar device graphs added in step 1805 (step 1808). The similar graph search unit 302 then calculates the similarity of the device graph 502 by utilizing the subroutine X (step 1809).

The similar graph search unit 302 decides whether or not the similarity of the device graph 502 calculated in step 1809 is above a threshold value (step 1810). If the similarity of the device graph 502 calculated in step 1809 is higher than the threshold value then the similar graph search unit 302 deletes the device graph 502 selected in step 1808 from the similar device graphs (step 1811) since the device graph 502 selected in step 1808 has no similarity.

If the similarity of the device graph 502 calculated in step 1810 is lower than the threshold value, or after step 1811, then the similar graph search unit 302 outputs the device graph 502 candidate stored in the similar device graph (step 1813). If plural device graphs 502 were stored in the similar device graph, then all of the device graphs 502 are output and the administrator may also select a device graph 502.

The similar graph search unit 302 then outputs the device cluster 407 contained in the device graph 502 having the smallest (degree of) similarity as a similar device cluster for processing in step 1701 of FIG. 17. When a similarity is 0, or namely when the comparison source and the comparison target device clusters are a complete match, a code book correction is not required so that the steps 1715-1719 in FIG. 17 are omitted and the branch can be set for shifting from step 1714 to step 1708. However when the similarity is greater than 0, or namely when the comparison source and the comparison target device clusters do not match, the device clusters are judged similar so that the threshold value is set and the applicable threshold value can be set beforehand by the user in the previously described similar graph search unit 302. However, when the output results in the device cluster processed by the similar graph search unit 302 were judged as unnecessary in step 1717 from results in an abnormal decision check from a past case previously described in step 1716 of FIG. 17, then the similarity of the device cluster when this (relearning) was judged unnecessary is substituted with a threshold value set beforehand by the user so that the similarity threshold value can also be set automatically. This automatic setting allows reducing the number of man-hours for optimizing of the user threshold value settings, and can also enhance an optimized objectivity or reproducibility. Moreover this automatic setting also allows extracting a device cluster not requiring relearning and the similarity is small at the step 1701 stage, so that the processing is speeded up by avoiding the relearning step.

A similar device graph 502 is acquired by way of the processing shown in FIG. 19, and a device cluster 407 corresponding to the acquired device graph 502 serves as the search results in step 1701.

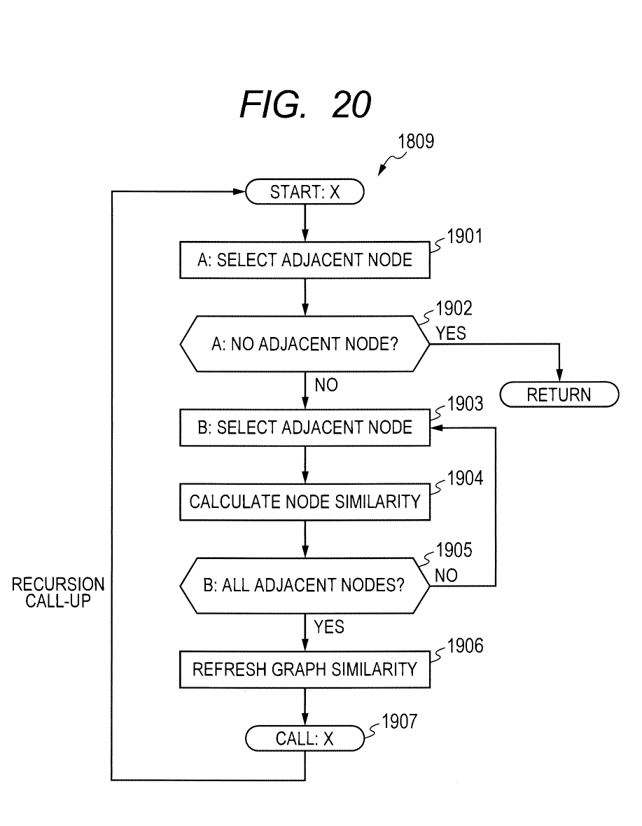

FIG. 20 is a flow chart showing the method for calculating the similarity of the device graphs 502 in the first embodiment of the present invention. The processing shown in FIG. 20 is equivalent to step 1809 in FIG. 19.

The similar graph search unit 302 selects the node A adjacent to the node A selected in step 1801 of FIG. 19 (step 1901). The similar graph search unit 302 decides if there is an adjacent node A in step 1801 or not (step 1902), and if there is no adjacent node A, then the similar graph search unit 302 ends the processing of subroutine X.

If there is an adjacent node A in step 1801, then the similar graph search unit 302 selects the node corresponding to the device graph 502 selected in step 1802, or in other words selects a node adjacent to the node B selected in step 1802 (step 1903).

For example if the similarity of the node A1 selected in step 1801 in FIG. 19 and the node B1 selected in step 1802 is lower than the threshold value, and if the device graph 502 contained in node B1 in step 1808 is selected in step 1903, the similar graph search unit 302 then selects node B2 adjacent to node B1 shown in FIG. 18A.

Next, the similar node search unit 303 calculates the similarity between the node A selected in step 1901 and node B selected in step 1903 (step 1904). The method for calculating the node similarity is described later on.

If the node A selected in step 1901 is for example node A2 shown in FIG. 18A, and node B selected in step 1903 is the node B2 shown in FIG. 18A, then the similar graph search unit 302 calculates the similarity of node A2 and node B2 in step 1904.

After step 1904, the similar graph search unit 302 then decides whether or not all nodes adjacent to node B selected in step 1802 were selected (step 1905). If all the nodes adjacent to node B were not selected then the similar graph search unit 302 returns to step 1903. If all the nodes adjacent to node B were selected, then the similar graph search unit 302 shifts to step 1906.

When the node B selected in step 1903 for example was the node B2 shown in FIG. 18A, then there is no other adjacent node to node B1 so that the similar graph search unit 302 decides that all nodes adjacent to node B1 were selected in step 1905.

The similar graph search unit 302 then adds the similarity of all adjacent nodes calculated in step 1904, and further adds this summed adjacent node similarity to the similarity of device graph 502 to refresh the similarity of the device graph 502 (step 1906).

When step 1906 is complete, the similar graph search unit 302 recursively calls up the subroutine X (step 1907) in order to also perform the processing on the node B selected in step 1903 same as the adjacent nodes. The similar graph search unit 302 stores the node A selected in 1901, and the node B with the smallest value among the similarities calculated in step 1094, and executes the recursively called subroutine X based on the stored node information.

If for example the node A selected in step 1901 was the node A2 shown in FIG. 18A; and the node B with the smallest value of similarity calculated in step 1904 was the node B2; then the similar graph search unit 302 selects the node A3 as the node A adjacent to node A2, in the recursive call subroutine X of step 1901. The similar graph search unit 302 selects the node B3 connected to node B2 in recursively called subroutine X in step 1903.

The similar graph search unit 302 searches for a node similar to the newly added node from the existing nodes, and acquires the device graph 502 corresponding to the similar node by the procedure shown in FIG. 19 and FIG. 20.

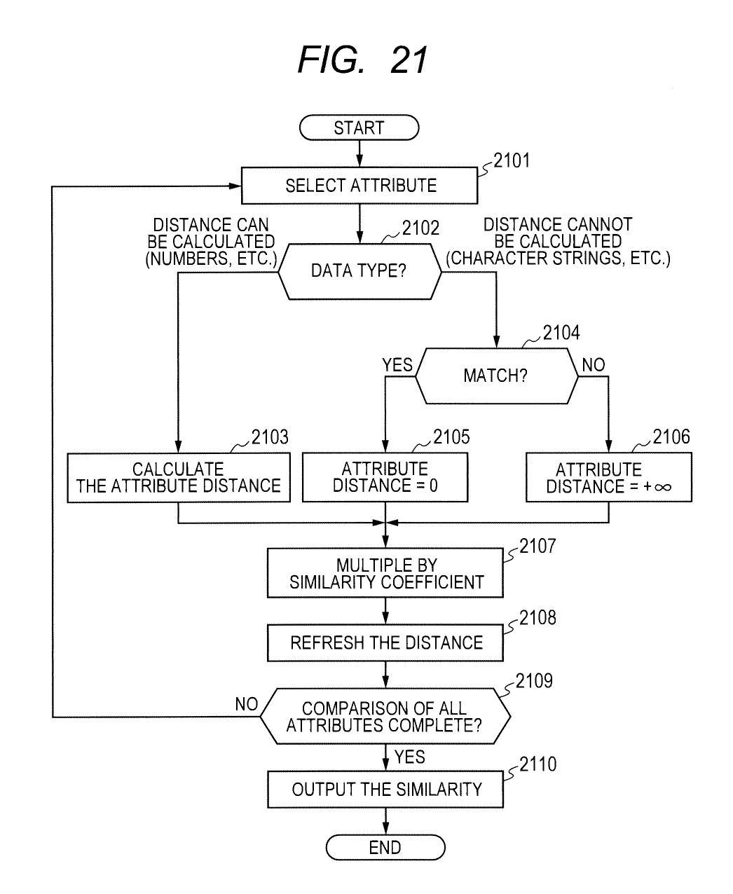

FIG. 21 is a flow chart showing the procedure for calculating the similarity of the nodes in the first embodiment of the present invention. The processing in FIG. 21 is identical to the processing in step 1803 of FIG. 19 and step 1904 in FIG. 20.

The similar node search unit 303 refers to the device information 702 for node A and node B when a new node A and existing node B were selected in step 1802 or step 1903. The similar node search unit 303 then selects an attribute 804 matching each of the attribute names 805 among the device information 702 for node A and node B (step 2101).

Next, the similar node search unit 303 decides if the data type 814 for the attribute 804 selected in step 2101 is a numerical value or a character string based on the schema information 810 (step 2102). If the data type 814 for the selected attribute 804 is a numerical value, and the attribute value 806 for node A and the attribute value 806 for node B can be mutually calculated, then the similar node search unit 303 calculates the attribute distance for node A and node B based on the attribute value 806 of the selected attribute 804 (step 2103).

Here, the attribute distance is a parameter quantitatively showing the difference between the two nodes.

If the data type 814 for the selected attribute 804 is a character string, and calculating among the attributes 806 is impossible, then the similar node search unit 303 decides if the attribute value 806 of node A and attribute value 806 of the selected node B are a match or not (step 2104). If the attribute value 806 of the selected node A and the attribute value 806 of node B are a match, then the similar node search unit 303 sets the attribute distance of the node A and node B to 0 (step 2105). If the attribute value 806 of the selected node A and the attribute value 806 of node B do not match, then the similar node search unit 303 sets the attribute distance between node A and node B to infinity (step 2106).

After performing step 2103, step 2105, or step 2106, the similar node search unit 303 multiplies the attribute distance between node A and node B calculated in step 2103, step 2105, or step 2106, by the similarity coefficient 815 decided beforehand according to the attribute name 805 (step 2107).

The similar node search unit 303 also refreshes the node similarity by using the value calculated in step 2107 (step 2108). In other words, the similar node search unit 303 calculates the node similarity by way of the following formula (2) using the attribute distance between the nodes and the similarity coefficient 815.

$${\sum }_{i ∈ All attributes}^{ } {k}_{i} \cdot {( {a}_{i} - {b}_{i} )}^{2} \qquad [ Formula 2 ]$$

The k in formula 2 denotes the similarity coefficient 815, which is established beforehand for each attribute. The aᵢ denotes a new node attribute value, and bᵢ denotes an existing node attribute value. The node similarity is calculated by finding the sum of multipliers obtained from the square of the difference between aᵢ and bᵢ times the similarity coefficient 815 for all attributes. The similarity coefficient 815 is stored in the schema information 810.

The similar node search unit 303 decides if the attribute distance and the node similarity were calculated for all attributes or not, and if all attributes were not calculated, returns to step 2101. If all attributes were calculated, then the similar node search unit 303 outputs the sum of the node similarities (step 2110), and the similarity calculation procedure then ends.

The processing shown in FIG. 21 calculated the node similarity however the sum of the node similarity is the similarity of the device graph 502. Moreover, the similarity of the device graph 502 is the similarity among the device clusters 407 or namely is the distance of the device clusters 407. The sum of the node similarity hereafter indicates the same meaning as the distance of the device clusters 407.

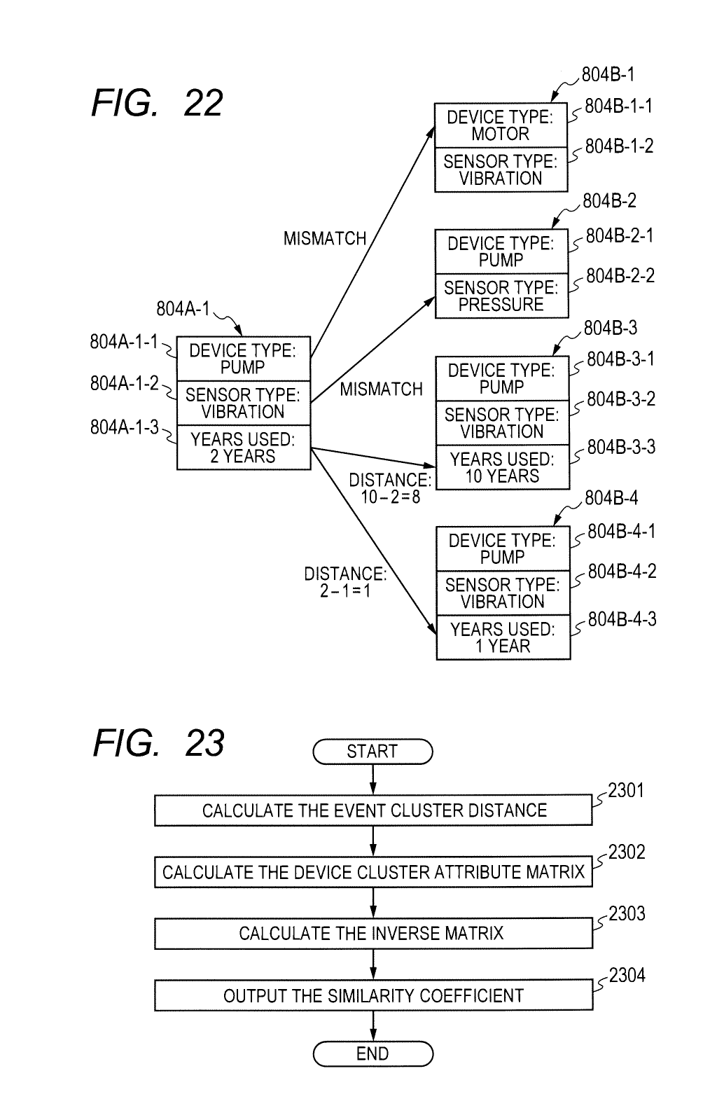

FIG. 22 is a descriptive drawing showing a specific example of calculating the attribute distance in the first embodiment of the present invention.

The attribute 804 of node A selected in step 1801 of FIG. 19 or step 1901 of FIG. 20 is shown as attribute 804A-1. Also, the attribute 804 of each node B selected from the existing node B in step 1802 or step 1903 is shown as the attributes 804B-1 through attribute 804B-4.

The attribute 804A-1 includes the attribute 804A-1-1, attribute 804A-1-2, and the attribute 804A-1-3. The attribute 804A-1-1 has “device type” as the attribute name 805; and “pump” as the attribute value 806. The attribute 804A-1-2 has “sensor type” as the attribute name 805; and “vibration” as the attribute value 806. The attribute 804A-1-3 has “years used” as the attribute name 805; and “2 years” as the attribute value 806.

The attribute 804B-1 includes the attribute 804B-1-1 and the attribute 804B-1-2. The attribute 804B-1-1 has “device type” as the attribute name 805; and “motor” as the attribute value 806. The attribute 804B-1-2 has “sensor type” as the attribute name 805; and “vibration” as the attribute value 806.

The attribute 804B-2 includes the attribute 804B-2-1 and the attribute 804B-2-2. The attribute 804B-2-1 has “device type” as the attribute name 805; and “pump” as the attribute value 806. The attribute 804B-2-2 has “sensor type” as the attribute name 805; and “pressure” as the attribute value 806.

The attribute 804B-3 includes the attribute 804B-3-1, the attribute 804B-3-2, and the attribute 804B-3-3. The attribute 804B-3-1 has “device type” as the attribute name 805; and “pump” as the attribute value 806. The attribute 804B-3-2 has “sensor type” as the attribute name 805; and “vibration” as the attribute value 806. The attribute 804B-3-3 has “years used” as the attribute name 805; and “10 years” as the attribute value 806.

The attribute 804B-4 includes the attribute 804B-4-1, the attribute 804B-4-2, and the attribute 804B-4-3. The attribute 804B-4-1 has “device type” as the attribute name 805; and “pump” as the attribute value 806. The attribute 804B-4-2 has “sensor type” as the attribute name 805; and “vibration” as the attribute value 806. The attribute 804B-4-3 has “years used” as the attribute name 805; and “1 year” as the attribute value 806.

When the attribute 804A-1-1 and the attribute 804B-1-1 were selected in step 2101 of FIG. 21, the attribute 804A-1-1 and the attribute 804B-1-1 both have character strings as the data type 814 so that a decision is made on whether the attribute values 806 are a match or not. These attribute values 806 are respectively a “pump” and “motor” and so are decided as a mismatch, and infinity is stored in the attribute distance.

Here, when the similarity coefficient 815 whose attribute 804 is “device type” and is not 0, the similarity of the device cluster 407 calculated in step 2110 becomes infinity.

When the attribute 804A-1-1 and the attribute 804B-2-1 were selected in step 2101 of FIG. 21, the attribute values 806 of the attribute 804A-1-1 and the attribute 804B-2-1 are both the same so that a “0” is stored in the attribute distance. Further, when the attribute 804A-1-2 and the attribute 804B-2-2 were selected, the attribute value 806 of the attribute 804A-1-2 is “vibration”, and the attribute value 806 of the attribute 804B-2-2 is “pressure” so that the attribute are decided as a mismatch in step 2104, and infinity is stored in the attribute distance.

When the attribute 804A-1-1 and the attribute 804B-3-1 were selected in step 2101 of FIG. 21, the attribute value 806 of the attribute 804A-1-1 and the attribute 804B-3-1 are the same so that a “0” is stored in the attribute distance. The attributes 804A-1-2 and the attribute 804B-3-2 likewise, both have the same attribute values 806 for the attribute 804A-1-2 and the attribute 804B-3-2 are the same so that a “0” is stored in the attribute distance.

When the attribute 804A-1-3 and the attribute 804B-3-3 were selected in step 2101 of FIG. 21, the attribute 804A-1-3 and the attribute 804B-3-3 both have numerical value as the data type 814 so that the attribute distance is calculated. The attribute value 806 of the attribute 804A-1-3 is “2 years”, and the attribute value 806 of the attribute 804B-3-3 is “10 years” so that the attribute distance is calculated as |2-10|=8.

When the attribute 804A-1-1 and the attribute 804B-4-1 were selected in step 2101 of FIG. 21, the attribute values 806 of the attribute 804A-1-1 and the attribute 804B-4-1 are both the same so that a “0” is stored in the attribute distance. The attribute 804A-1-2 and the attribute 804B-4-2 likewise, both have the same attribute value 806 for the attribute 804A-1-2 and the attribute 804B-4-2 so that a “0” is stored in the attribute distance.

When the attribute 804A-1-3 and the attribute 804B-4-3 were selected in step 2101 of FIG. 21, the attribute 804A-1-3 and the attribute 804B-4-3 both have numerical value as the data type 814 so that the attribute distance is calculated. The attribute value 806 of the attribute 804A-1-3 is “2 years”, and the attribute value 806 of the attribute 804B-4-3 is “1 year” so that the attribute distance is calculated as |2−1|=1.

The attribute distance in the present embodiment is calculated as previously described. The calculated attribute distance is multiple by the similarity coefficient 815, and added to the similarity of the device cluster 407. If the attribute values 806 are a match, then a “0” was stored in the attribute distance, however any value that is as small as possible but is not “0” may be stored. The administrator can in this way calculated the node similarity so that a more important attribute 804 can be selected.

The procedure for calculating the similarity coefficient 815 is shown next.

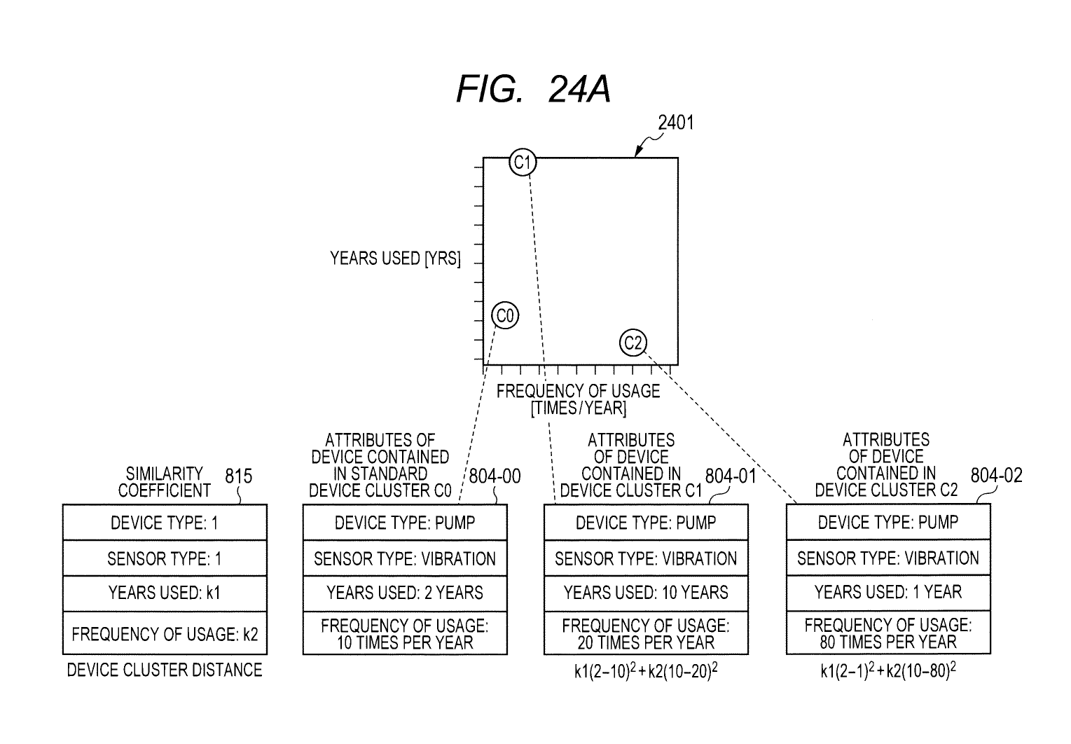

FIG. 23 is a flow chart showing the procedure for calculating the similarity coefficient 815 in the first embodiment of the present invention.

First of all, the similar node search unit 303 calculates the distance of the event cluster 1308 corresponding to each device cluster 407 (step 2301). Here, when there are N number of similarity coefficients 815 to calculate, the sum total of volumes in the device cluster 407 contained in the attribute 804 corresponding to similarity coefficient 815; and also in the dimension of the corresponding event cluster 1308 is shown by Si (i=0 through N).

Device clusters 407 equal in number to the attributes 804 corresponding to the similarity coefficient 815, and one device cluster 407 serving as the reference for calculating the similarity coefficient 815 are selected beforehand for the device cluster 407 utilized for calculating the similarity coefficient 815.

The “dimension” for the total sum of volume Si in the dimension of event cluster 1308 is the number of elements V shown in the FIG. 13A corresponding to the event cluster 1308. The “dimensional volume” shows the volumetric range to distribute the event cluster 1308 in each dimension. The “sum total” is the value from summing all the volumes of each event cluster 1308 because there are plural event clusters 1308 for each event 1305.

Here, S0 is the sum total of the volume in the dimension of the event cluster 1308 corresponding to the device cluster 407 serving as a reference for calculating the similarity coefficient 815. The event cluster 1308 distance is defined by the formula 3 shown below.

$$\frac{\vert {S}_{i} - {S}_{0} \vert}{\vert {S}_{0} \vert} \qquad [ Formula 3 ]$$

Here, |Si−S0| is the difference between the sum total of the volumes of the event cluster 1308. Formula 3 is used to calculate the percentage that the difference between the sum total of the volumes of the event cluster 1308 as an object for comparison and the sum total of the volumes of the event cluster 1308 serving as a reference, occupies in the sum total of the volumes of the event cluster 1308 serving as the reference, and those calculated results then define the distance of the event cluster 1308.

The similar node search unit 303 calculates the distance of the event cluster 1308 by way of the formula 3.

Here, when the distance of the event cluster 1308 and the distance of the device cluster 407 are equal, then the following calculation can be made using formula 1 and formula 3.

$$[ \begin{matrix}{( {b}_{11} - {a}_{01} )}^{2} & … & {( {b}_{1 N} - {a}_{0 N} )}^{2} \\ ⋮ & ⋱ & ⋮ \\ {( {b}_{N 1} - {a}_{01} )}^{2} & … & {( {b}_{NN} - {a}_{0 N} )}^{2}\end{matrix} ] [ \begin{matrix}{k}_{1} \\ ⋮ \\ {k}_{N}\end{matrix} ] = \frac{1}{\vert {S}_{0} \vert} [ \begin{matrix}\vert {S}_{1} - {S}_{0} \vert \\ ⋮ \\ \vert {S}_{N} - {S}_{0} \vert\end{matrix} ] \qquad [ Formula 4 ]$$

Here, aji denotes the value for attribute 804 contained in the device cluster 407 serving as the reference, and bji denotes the attribute 804 contained in the device cluster 407 serving as the object for comparison. The i denotes the number of similarity coefficients 815 for calculation as previously described or in other words is the number of attributes 804. The j is the number of device clusters 407 serving as the object for comparison or in other words is the number of similarity coefficients 815 for calculation.

The first term on the left side is an expression describing the distance of the device cluster 407 by way of a matrix. The right side is an expression showing the distance of the event cluster 1308 calculated in step 2301 by way of a matrix.

The similar node search unit 303 calculates the matrix showing the distance of the device cluster 407 (step 2302). The similar node search unit 303 further calculates the value for ki serving as the similarity coefficient 815 by calculating the inverse matrix on the left side of formula 4 (step 2303). The similar node search unit 303 then outputs the calculated value for the similarity coefficient 815 (step 2304).

The similarity coefficient 815 is therefore calculated as described above.

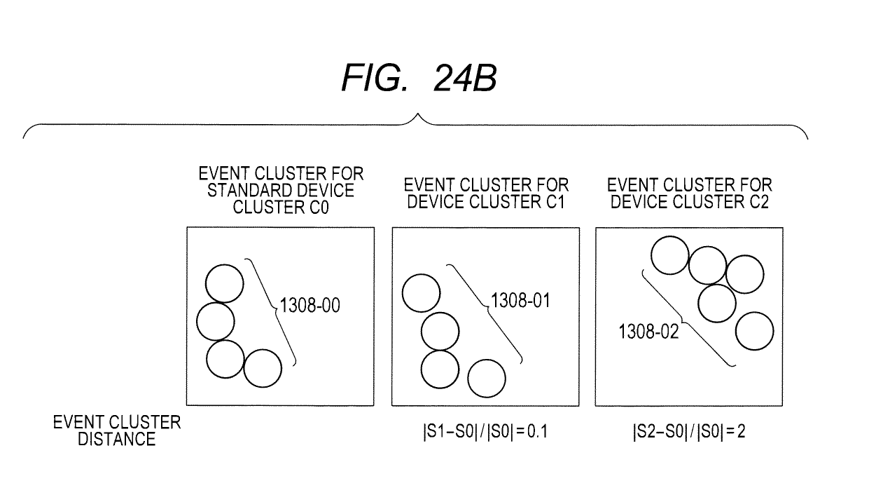

FIG. 24A is a descriptive drawing showing an example of the distance of the device cluster 407 in the first embodiment of the present invention.

The Table 2041 is a table showing the distance of the device clusters C0-C3 (407) utilizing the attribute 804 of the nodes contained in each of the device cluster C0 (407), device cluster C1 (407), and the device cluster C2 (407). The horizontal axis in Table 2401 is the frequency of usage, and the vertical axis is the years used. The vertical axis and the horizontal axis in Table 2401 correspond to the attribute name 805.

The attribute 804-00 for the node contained in the device cluster C0 (407) has 2 years as the used years, and 10 times per year as the frequency of usage. The attribute 804-01 for the node contained in device cluster C1 (407) has 10 years as the used years, and 20 times per year as the frequency of usage. The attribute 804-02 for the node contained the device cluster C2 (407) has 1 year as the used years, and 80 times per year as the usage frequency.

In the similarity coefficient 815 for the years used are shown by k1, and the frequency of usage for the similarity coefficient 815 is shown by k2.

When using the device cluster C0 (407) as a reference, the distance for device cluster C1 (407) is k1 (2-10) 2+k2 (10-20)2; and the distance for the device cluster C2 (407) is k1 (2-1)2+k2 (10-80)2.

FIG. 24B is a descriptive drawing showing an example of the distance of the event cluster 1308 in the first embodiment of the present invention.

The event cluster 1308 of device cluster C0 (407) is plural true spheres shown by the event clusters 1308-00 in FIG. 24B. The event cluster 1308 of device cluster C1 (407) is plural true spheres shown by the event clusters 1308-01. The event cluster 1308 of device cluster C2 (407) is plural true spheres shown by the event clusters 1308-02 in FIG. 24B.

The sum total of the volume of the true spheres of the event cluster 1308-00 is shown by S0, the sum total of the volume of the true spheres of the event cluster 1308-01 is shown by S1, and the sum total of the volume of the true spheres of the event cluster 1308-02 is shown by S2.

The distance of the event cluster 1308 between the device cluster C0 (407) and the device cluster C1 (407) by way of the above described formula 3 is shown by |S1−S0|/|S0|. The event clusters 1308-00 and the event clusters 1308-1 shown in FIG. 24B mostly overlap so that the value of |S1−S0| is smaller than |S0|. The |S1−S0|/|S0| is therefore a value smaller than 1.

The distance of the event cluster 1308 between the device cluster C0 (407) and device cluster C2 (407) on the other hand is shown by |S2−S0|/|S0|. The event cluster 1308-00 and the event cluster 1380-02 shown in FIG. 24B do not overlap so that the |S2−S0|/|S0| is a value larger than 1.

Utilizing the distance for the event cluster 1308, and the device cluster 407 calculated as described above allows establishing the simultaneous equation as shown below.

k1(2-10)²+k2(10-20)²=|S1−S0|/|S0|

k1(2-1)²+k2(10-80)²=|S2−S0|/|S0| [Formula 5]

If the value for |S1−S0|/|S0| is set as 0.1, and the value for |S2−S0|/|S0| is set as 2, then the value for k1 is calculated as 9.3e-4 (logarithmic notation), the value for k2 as 4.1e-4.

The first embodiment renders the effect that the man-hours required for setting examination rules can be reduced, and that examination rules for the new device 102 or pipe 103 can be set at an early stage, even if a new device 102 or pipe 103 was added, by applying an existing device cluster 407 to the new device 102 or pipe 103 having a structure similar to an existing device 102 or pipe 103.

### Second Embodiment

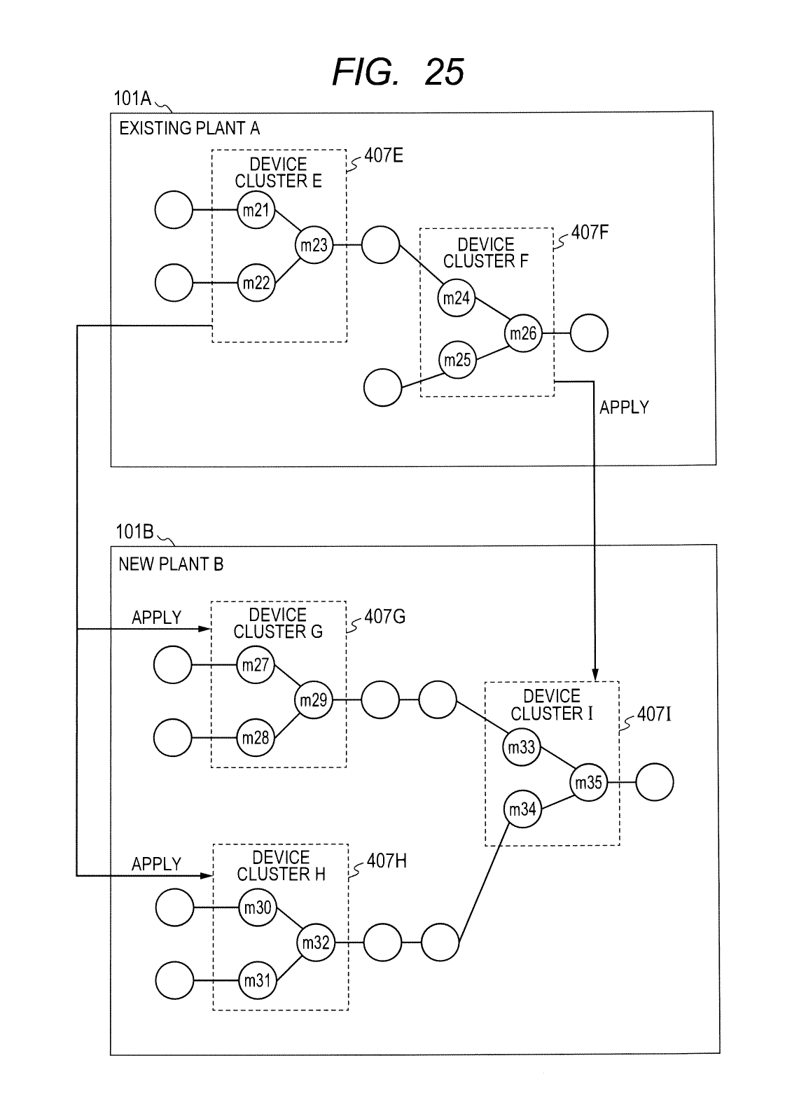

FIG. 25 is a descriptive drawing showing an example of applying a device cluster 407 to a new plant 101 in the second embodiment of the present invention.

As can be seen in FIG. 25, the existing plant 101A contains the device or pipes m21-m26; and the new plant 101B contains the device or pipes m27-m35.

In the present invention, when a plant 101B was added to an existing plant 101A, and a device cluster 407E and device cluster 407F were set in the existing plant 101A, the device cluster 407E and device cluster 407F are applied to the device 102 or pipe 103 contained in the newly added plant 101B.

A device combination having a device graph 502 similar to the device graph 502 for m21-m23 is extracted from the new plant 101B, and applies the device cluster 407E for the devices or pipes m21-m23 to this extracted device combination. The device cluster 407G and device cluster 407H are in this way generated in the device or pipes m27-m29 and m30-m32 as shown in the example in FIG. 25.

A device combination having a device graph 502 similar to the device graph 502 of the devices or pipes m24-m26 is also extracted from the new plant 101B, and applies the device cluster 407I for the device or pipe m24-m26 to this extracted device combination. The device cluster 407I are in this way generated in the device or pipes m33-35 as shown in the example in FIG. 25.

Therefore, even if a new plant 101B was added, the second embodiment is capable or reducing the number of required user man-hours and setting the examination rules at an early stage in the plant 101B by applying the device cluster 407 contained in the existing plant 101A.

The present embodiment was described above in detail while referring to the accompanying drawings however the present invention is not limited to these types of specific structures and may also include all manner of changes and equivalent structures that fall within the range of the appended claims.

1. A computer system including a plurality of sensors mounted in a plurality of devices to measure specified physical quantities, and a server to examine the physical quantities sent from the sensor,
wherein the devices are classified into a first device group, and a plurality of second device groups,
wherein the second device groups include a plurality of second examination rules showing examination methods for the physical quantities, and
wherein the server calculates the similarity between the first device group and each of the second device groups, and extracts a first examination rule set in the first device group from the second examination rules set in the second device groups based on the calculated similarity.

2. The computer system according to claim 1,
wherein the server:
selects the first device from the first device group, and
selects the second device from the second device group, and calculates the similarity between the selected first device and the second device, and
calculates the similarity between the first device group and the second device group based on the calculated similarity between the first device and the second device.

3. The computer system according to claim 2,
wherein the server:
calculates the similarity between the first device group and the second device group when the similarity between the first device and the second device is below a first specified threshold, and
searches for the second device group whose calculated similarity of the first device group and the second device group is lower than a second specified threshold from the second device groups, and
extracts the first examination rule to be set in the first device group from the second examination rule set in the searched second device group.

4. The computer system according to claim 2,
wherein the server:
selects a third device adjacent to the first device in the first device group,
selects a fourth device, when there is a fourth device adjacent to the second device in the second device group, and
calculates the similarity between the third device and the fourth device,
selects a fifth device adjacent to the third device in the first device group,
selects a sixth device, when there is a sixth device adjacent to the fourth device in the second device group,
calculates the similarity between the fifth device and the sixth device, and
calculates the similarity between the first device group and the second device group, by summing the similarity between the first device and the second device, the similarity between the third device and the fourth device, and the similarity between the fifth device and the sixth device.

5. The computer system according to claim 2,
wherein the server:
retains attribute corresponding to the device and the value of the attribute,
calculates the distance of the attribute by comparing the value of the attribute corresponding to the first device, with the value of the attribute corresponding to the second device, and
calculates the similarity between the first device and the second device by multiplying the distance of the attribute by the coefficient.

6. The computer system according to claim 5, including the examination rule contains information relating to an event corresponding to the measured physical quantity,
wherein the server:
sets one group among the second device groups as the third device group, and another group among the second device groups as the fourth device group, and
calculates a third range of a physical quantity having
a high possibility of a particular event occurring, based on information relating to the event corresponding to the third device group, and
calculates a fourth range of a physical quantity having a high possibility of a particular event occurring, based on information relating to the event corresponding to the fourth device group, and
calculates the percentage that the difference between the third range and the fourth range occupies in the third range, and
finds the coefficient based on the similarity between the third device group and the fourth device group, and the calculated percentage.

7. The computer system according to claim 1, including a method for processing the physical quantity set in a device belonging to the second device groups in order to examine the physical quantity,
wherein the server extracts a first method for processing the physical quantity set in the first device group, from a second method for processing a physical quantity set in the second device groups based on the calculated similarity.

8. The computer system according to claim 1,
wherein the server:
outputs the event corresponding to the physical quantity measured by the sensor in a specified period based on the information relating to the event contained in the examination rule, and
acquires information showing whether or not information relating to the output event requires refreshing, and
refreshes information relating to the output event when refreshing of the information relating to the output event is required.

9. The computer system according to claim 8,
wherein the server:
acquires the physical quantity measured by the sensor in a specified period, and the event that occurred in the specified period, and
refreshes the information relating to the event by way of the acquired physical quantity and event.

10. A rule generation method according to a plurality of sensors installed in a plurality of devices to measure specified physical quantities, and a server to examine the physical quantities sent from the sensors,
the devices being grouped into a first device group, and a plurality of second device groups, and
the second device groups containing a plurality of second examination rules showing examination methods for the physical quantities,
the rule generation method comprising:
a procedure for the server to calculate the similarity between the first device group and each of the second device groups; and
a procedure for the server to extract a first examination rule to be set in the first device group from the second examination rules set in the second device groups based on the calculated similarity.

11. The rule generation method according to claim 10,
wherein the procedure to calculate the similarity between the first device group and each of the second device groups includes:
a procedure for the server to select the first device from the first device group;
a procedure for the server to select the second device from the second device groups;
a procedure for the server to calculate the similarity between the selected first device and the second device; and
a procedure for the server to calculate the similarity of the first device group and the second device group when the similarity between the first device and the second device is below a first specified threshold value,
wherein the procedure for extracting the first examination rule includes:
a procedure for searching for the second device group whose similarity between the calculated first device group and second device group is lower than a second specified threshold value; and
a procedure for extracting a first examination rule to be set in the first device group from a second examination rule set in the searched second device group.

12. The rule generation method according to claim 11,
wherein a procedure to calculate the similarity of the first device group and second device group comprises:
a procedure for the server to select a third device adjacent to the first device in the first device group;
a procedure for the server to select a fourth device when there is a fourth device adjacent to the second devices in the second device group;
a procedure for the server to calculate the similarity between the third device and the fourth device;
a procedure for the server to select a fifth device adjacent to the third device in the first device group;
a procedure for the server to select a sixth device when there is a sixth device adjacent to the fourth device in the second device group;
a procedure for the server to calculate the similarity between the fifth device and the sixth device; and
a procedure for the server to calculate the similarity between the first device group and the second device group by summing the similarity between the first device and the second device, and the similarity between the third device and the fourth device, and the similarity between the fifth device and the sixth device.

13. The rule generation method according to claim 11, the examination rule containing information relating to an event corresponding to a measured physical quantity,
the method comprising:
a procedure for the server to set one group among the second device groups as the third device group, and another group among the second device groups as the fourth device group;
a procedure for the server to calculate a third range of the physical quantity having a high possibility of an event occurring based on information relating to the event corresponding to the third device group;
a procedure for the server to calculate a fourth range of a physical quantity having a high possibility of the applicable event occurring based on information relating to the event corresponding to a fourth device group;
a procedure for the server to calculate the percentage that the difference between the third range and the fourth range occupies in the third range; and
a procedure for the server to find the coefficient based on the similarity between the third device group and the fourth device group, and the calculated percentage,
wherein the server retains the attribute corresponding to the device and the value of the attribute, and
the procedure for the server to calculate the similarity between the first device and the second device includes:
a procedure for the server to calculate the distance of the attribute by comparing the attribute value corresponding to the first device, with the attribute value corresponding to the second device; and
a procedure for the server to calculate the similarity between the first device and the second device by multiplying the attribute distance by the coefficient.

14. The rule generation method according to claim 10,
wherein a method for processing the physical quantity is set in the second device groups in order to examine the physical quantity; and
the procedure for extracting the first examination rule includes:
a procedure for extracting a first method for processing a physical quantity to be set in the first device group from a second method for processing a physical quantity set in the second device groups, based on the calculated similarity.

15. The rule generation method according to claim 10,
wherein the method comprises:
a procedure for the server to output the event corresponding to the physical quantity measured by the sensor in a specified period, based on information relating to an event contained in the examination rule;
a procedure for the server to acquire information showing whether refreshing of information relating to the event that was output is required or not;
a procedure for the server to acquire the event that occurred in the specified period, and a physical quantity measured by the sensor in a specified period, when information relating to the event that was output must be refreshed; and
a procedure for the server to refresh information relating to the event by way of the acquired physical quantity and the event.
